(19) United States
(12) Patent Application Publication
(10) Pub. No.: US 2015/0064773 A1
(43) Pub. Date: Mar. 5, 2015

(54) Detergent Composition and Substitution of Optical Brighteners in Detergent Composition

(71) Applicant: Novozymes A/S, Bagsvaerd (DK)

(72) Inventor: Nickolass Schack, Copenhagen (DK)

(21) Appl. No.: 14/377,924

(22) PCT Filed: Mar. 6, 2013
(86) PCT No.: PCT/EP2013/054520

§ 371 Date: Aug. 11, 2014

Related U.S. Application Data
(60) Provisional application No. 61/608,344, filed on Mar. 8, 2012.
(60) Provisional application No. 61/657,968, filed on Jun. 11, 2012.

(30) Foreign Application Priority Data
Mar. 7, 2012 (EP) 12158477.5
Jun. 8, 2012 (EP) 12171238.4

(51) Int. Cl. C11D 3/386; C11D 3/42

(52) U.S. Cl. CPC C11D 3/38645; C11D 3/42
USPC 435/263; 510/320

(57) ABSTRACT

The present invention relates to a method for reformulating a detergent composition wherein a first detergent formulation comprising an optical brightener is reformulated by reducing the amount of optical brightener by at least 20% and including a cellulase. The invention further relates to detergent compositions comprising an optical brightener and a cellulase wherein the optical brightener is comprised at a level of at most 0.75% by weight of the composition and the cellulase is present in an amount of atleast 0.5 ECU/g of the composition.

### REFERENCE TO A SEQUENCE LISTING

This application contains a Sequence Listing in computer readable form, which is incorporated herein by reference.

### FIELD OF INVENTION

This invention relates to a detergent composition comprising a cellulase, the use of a cellulase, a method for maintaining or improving the whiteness of a textile, a method for reformulating a detergent composition by reducing the amount of optical brighteners by addition of a cellulase, a method of washing a textile and a textile washed by the method. The invention further relates to detergent compositions comprising at most 0.75% by weight of the composition of an optical brightener and a cellulase and from 0.1 percent to 60 percent by weight of surfactant.

### DESCRIPTION OF THE RELATED ART

Microbial hydrolysis of cellulose to glucose involves the following three major classes of cellulases: (i) endo-glucanases (EC 3.2.1.4) which cleave beta-1,4-glucosidic links randomly throughout cellulose molecules, also called endo-beta-1,4-glucanases; (ii) cellobiohydrolases (EC 3.2.1.91) which digest cellulose from the non-reducing end, releasing cellobiose; and (iii) beta-glucosidases (EC 3.2.1.21) which hydrolyse cellobiose and low molecular-weight cellodextrins to release glucose.

Cellulases are synthesized by a large number of microorganisms which include fungi, actinomycetes, myxobacteria and true bacteria but also by plants. Especially endo-beta-1,4-glucanases of a wide variety of specificities have been identified. Many bacterial endo-glucanases have been described (Gilbert, H. J. and Hazlewood, G. P. (1993) J. Gen. Microbiol. 139:187-194. Henrissat, B., and Bairoch, A.: New families in the classification of glycosyl hydrolases based on amino acid sequence similarities. Biochem. J. 293 (1993), 781-788).

An important industrial use of cellulolytic enzymes is as ingredients in detergent compositions where they have been added for their ability to remove cellulose containing stains as well as for their anti-redeposition and color care effect.

One important objective when washing white textile is to maintain the whiteness of the textile. Thus evaluations of detergency performance of detergent compositions in particular compositions for white textiles must include consideration of the obtained whiteness of the washed textile.

Optical brighteners are known in the art of detergent compositions and are used in such to contribute to whiteness maintenance of textiles. However, optical brighteners can cause allergic reactions and this in one reason that it is desired to reduce the amount of optical brighteners in detergent compositions.

It is therefore an object of the present invention to provide a detergent composition having a reduced amount of optical brighteners while maintaining an acceptable wash performance of the composition, in particular acceptable whiteness maintenance or even improved whiteness maintenance of textiles treated with the detergent composition having a reduced amount of optical brighteners.

It is another object of the present invention to provide a method for reformulating a detergent composition by reducing the amount of optical brightener in said reformulated composition while maintaining an acceptable and/or improved wash performance of the reformulated composition.

### SUMMARY OF INVENTION

The present inventor has surprisingly found that an enzyme exhibiting cellulase activity can substitute significant amounts of optical brighteners in liquid and powder detergent compositions without impairing the whiteness maintenance and the inventor has found that the whiteness of the treated textiles may even be improved by this substitution.

In one embodiment, the invention concerns a detergent composition comprising: an optical brightener, at a level of at most 0.75% by weight of the composition, a cellulase and from 0.1 percent to 60 percent by weight of surfactant.

In one embodiment of the invention, the invention relates to the use of a cellulase for reducing the amount of optical brightener in a detergent composition comprising an optical brightener.

In one embodiment, the invention relates to a method for maintaining or improving the whiteness of a textile, wherein the textile is exposed to a detergent comprising an optical brightener and a cellulase.

In one embodiment, the invention relates to a method for reformulating a detergent composition wherein a first detergent formulation comprising an optical brightener and providing a given Y value is reformulated by reducing the amount of optical brightener by at least 20% of the amount in the first detergent formulation and including a cellulase in an amount so that the Y value provided by the reformulated composition is equal to or higher than the Y value provided by the first detergent formulation.

In one embodiment the invention relates to washing a textile comprising a step of contacting said textile with the composition of the invention, then optionally washing and/or rinsing said textile.

In one embodiment the invention concerns a textile washed by the inventive method.

### DEFINITIONS

Prior to discussing this invention in further detail, the following terms and conventions will first be defined.

The term optical brighter as used herein is used interchangeably with the terms optical brightening agents, fluorescent brightening agents or fluorescent whitening agents. Optical brighteners are dyes that absorb light in the ultraviolet and violet region (usually 340-370 nm) of the electromagnetic spectrum, and re-emit light in the blue region (typically 420-470 nm). These additives are often used to enhance the appearance of color of fabric and paper, causing a “whitening” effect, making materials looks less yellow by increasing the overall amount of blue light coming from the material/object.

As used herein the term “a cellulase” means endo-glucanases (EC 3.2.1.4) which cleave beta-1,4-glucosidic links randomly throughout cellulose molecules, also called endo-beta-1,4-glucanases.

ECU

The activity units, ECU, are determined by the reduction of viscosity of CMC (carboxymethyl cellulose) in a vibration viscosimeter. 1 ECU (endo-cellulase unit) is the amount of activity which causes a 10-fold reduction of viscosity when incubated with 1 ml of a solution of 34.0 g/L of CMC (trade name Aqualon 7LFD) in 0.1 M phosphate buffer (pH 7.5), 40° C. for 30 minutes. A vibration viscosimeter such as MIVI 3000, Sofraser®, France may be used to measure the viscosity.

Textile: The term “textile” means any textile material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, ramie, cellulose acetate fibers (tricell), lyocell or blends thereof. The textile or fabric may also be non-cellulose based such as natural polyamides including wool, camel, cashmere, mohair, rabbit and silk or synthetic polymer such as nylon, aramid, polyester, acrylic, polypropylen and spandex/elastane, or blends thereof as well as blend of cellulose based and non-cellulose based fibers. Examples of blends are blends of cotton and/or rayon/viscose with one or more companion material such as wool, synthetic fibers (e.g. polyamide fibers, acrylic fibers, polyester fibers, polyvinyl alcohol fibers, polyvinyl chloride fibers, polyurethane fibers, polyurea fibers, aramid fibers), and cellulose-containing fibers (e.g. rayon/viscose, ramie, flax/linen, jute, cellulose acetate fibers, lyocell). Fabric may be conventional washable laundry, for example stained household laundry. When the term fabric or garment is used it is intended to include the broader term textiles as well.

Sequence identity: The relatedness between two amino acid sequences or between two nucleotide sequences is described by the parameter “sequence identity”.

For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows:

(Identical Residues×100)/(Length of Alignment−Total Number of Gaps in Alignment)

For purposes of the present invention, the sequence identity between two deoxyribonucleotide sequences is determined using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra), preferably version 5.0.0 or later. The parameters used are gap open penalty of 10, gap extension penalty of 0.5, and the EDNAFULL (EMBOSS version of NCBI NUC4.4) substitution matrix. The output of Needle labeled “longest identity” (obtained using the -nobrief option) is used as the percent identity and is calculated as follows:

(Identical Deoxyribonucleotides×100)/(Length of Alignment−Total Number of Gaps in Alignment)

Y value—The Y value is one of the three CIE (International Commission on Illumination) Tristimulus values X, Y and Z, which are often used in the description of color perception and color measurement. The CIE Tristimulus values X, Y and Z are calculated from the CIE 1964 10° Standard Observer functions taking into account the type of illumination and reflectance of the object. The formulas are as follows:

| | | |
|---|---|---|
| X = k∫₀^{∞}I(λ) x̅(λ)dλ | Y = k∫₀^{∞}I(λ) y̅(λ)dλ | Z = k∫₀^{∞}I(λ) z̅(λ)dλ |

x̅(λ), y̅(λ) and z̅(λ) are the CIE 1964 10° Standard Observer functions, and I(λ) is the color stimulus function of the irradiation from the material being investigated. k is a normalization factor given by formula:

k=100/∫₀^{∞}S(λ) y̅(λ)dλ

S(λ) is the relative spectra power of a standard CIE illuminant. The CIE method for calculating the Y value is further described in “Billmeyer, F. W. and Fairman, H. S. (1987), CIE Method for Calculating Tristimulus Values; Color Research & Application, 12: 27-36”.

The Y value for a given object is the luminous reflectance for that object and for that reason the Y value is often used to characterize the degree of whiteness of white textiles, e.g. in the EU Ecolabel performance test for laundry detergents. The Y value can be determined using any suitable Spectrophotometer that is capable of quantifying the color stimulus function and of performing the mathematical operations stated by formulas above. The Y values as presented herein in the Examples have been measured using a Konica Minolta Vertical Spectrophotometer, model CM-3610d with the following operational settings:

Light source: Xenon lamp

Illuminant: D₆₅

UV light: Included

Specular: Excluded

Standard observer+color matching functions: CIE 1964 10°

The term “ΔY value” as used herein means the difference between the Y value measured after a washing step with a detergent comprising an optical brightener and the Y value measured after a washing step with a detergent comprising an optical brightener and a cellulase. Accordingly, ΔY value is: (the Y value measured after a washing step with a detergent comprising an optical brightener) minus (the Y value measured after a washing step with a detergent comprising an optical brightener and a cellulase).

For example, the ΔY value is 2.1 when the Y value measured after a washing step comprising an optical brightener is 88.7 and the Y value measured after a washing step with a detergent comprising an optical brightener and a cellulase is 90.8.

Wash performance: The term “wash performance” is used as the capability of the detergent composition to remove stains present on the object to be cleaned during e.g. wash or hard surface cleaning and/or the ability to restore, maintain or improve the whiteness of a textile treated with the composition. The improvement in the wash performance may be quantified by the Tristimulus Y value as described above.

Improved whiteness maintenance as used herein means the ability of the detergent composition of the present invention containing a reduced amount of optical brightener and a cellulase to obtain identical or higher Y values for textiles treated with the composition, compared to the obtained Y value of identical textile treated with a comparable detergent composition comprising a higher amount or percentage of optical brightener with or without the presence of a cellulase.

The term “improved whiteness” as used herein means that a textile shows a positive ΔY value. The ΔY value should be at least 0, such as at least 0.3, at least 0.5 at least 0.8, at least 1, at least 1.5 or at least 2.

The term “maintained whiteness” as used herein means that the ΔY value is zero.

Whiteness: The term “Whiteness” is defined herein as a broad term with different meanings in different regions and for different consumers Loss of whiteness can e.g. be due to greying, yellowing, or removal of optical brighteners/hueing agents. Greying and yellowing can be due to soil redeposition, body soils, colouring from e.g. iron and copper ions or dye transfer. Whiteness might include one or several issues from the list below: Colorant or dye effects; Incomplete stain removal (e.g. body soils, sebum ect.); Re-deposition (greying, yellowing or other discolorations of the object) (removed soils re-associates with other part of textile, soiled or unsoiled); Chemical changes in textile during application; and Clarification or brightening of colours.

The term “wash liquid” means a liquid comprising a detergent. The liquid is usually water. The detergent is dissolved or partly dissolved in the liquid e.g. water.

In one embodiment, the invention is directed to detergent compositions comprising an optical brightener and a cellulase in combination with one or more additional cleaning composition components. The composition preferably comprise from 0.1 percent to 60 percent by weight of surfactant. The choice of additional components is within the skill of the artisan and includes conventional ingredients, including the exemplary non-limiting components set forth below. The choice of components may include, for textile care, the consideration of the type of textile to be cleaned, the type and/or degree of soiling, the temperature at which cleaning is to take place, and the formulation of the detergent product. Although components mentioned below are categorized by general header according to a particular functionality, this is not to be construed as a limitation, as a component may comprise additional functionalities as will be appreciated by the skilled artisan.

### DETAILED DESCRIPTION OF THE INVENTION

The present invention concerns a detergent composition comprising: an optical brightener, at a level of at most 0.75% by weight of the composition, a cellulase and from 0.1 percent to 60 percent by weight of surfactant.

The present invention concerns the use of a cellulase for reducing the amount of optical brightener in a detergent composition comprising an optical brightener. By the use of a cellulase the amount of optical brightener can be reduced by at least 20%.

The reduction of optical brightener in detergents is desired as optical brigthteners can cause allergic reactions and it is therefore desirable to reduce the amount of optical brightener in detergent compositions. Accordingly, in one embodiment of the invention, the amount of optical brightener is reduced by at least 30%, by at least 40%, by at least 50%, by at least 60%, by at least 70%, by at least 75%, by at least 80% or by at least 90%

In one embodiment the invention concerns a method for maintaining and/or improving the whiteness of a textile, wherein the textile is exposed to a wash liquid with a detergent comprising an optical brightener and a cellulase.

In one embodiment the invention relates to washing a textile comprising a step of contacting said fabric with the composition of the invention, then optionally washing and/or rinsing said textile.

In one embodiment the invention concerns a textile washed by the inventive method.

The present invention also relates to a method for reformulating a detergent composition wherein a first detergent composition comprising an optical brightener and providing a given Y value is reformulated by reducing the amount of optical brightener by at least 20% and including a cellulase in an amount so that the Y value provided by the reformulated composition is equal to or higher than the Y value provided by the first detergent formulation.

The cellulase of the present invention may be one or more cellulases exhibiting endo-beta-1,4-glucanase activity. Preferably, the cellulase is alkaline, so that the cellulase is suitable for use in detergent compositions. In one embodiment, the alkaline cellulase has a pH optimum above 7. In another embodiment the cellulase has a pH optimum above 8. In yet another embodiment, the cellulase retains greater than 70% of its optimal activity at pH 10. The cellulases may be of bacterial, fungal or archaeal origin.

In one embodiment of the invention, the cellulase is obtainable by or derived from a strain of Humicola, Trichoderma, Myceliophthora, Penicillium, Irpex, Aspergillus, Scytalidium, Thielavia or Fusarium.

In another embodiment, the cellulase is obtainable by or derivable from a strain of Humicola insolens, Fusarium oxysporum, Myceliophthora thermophile, Thielavia terrestris or Trichoderma reesei.

In yet another embodiment the cellulase is a bacterial polypeptide obtainable by or derivable from a member of the genus Bacillus.

In an embodiment of the present invention the cellulase is obtainable by or derivable from a strain of Bacillus sp., AA 349, DSM 12648. The strain Bacillus sp. AA349, which has been isolated from a soil sample originating in Greece, was deposited according to the Budapest Treaty on the International Recognition of the Deposit of Microorganisms for the Purposes of Patent Procedure at the Deutsche Sammlung von Mikroorganismen and Zellkulturen GmbH, Mascheroder Weg 1 b, D-38124 Braunschweig, Federal Republic of Germany, on 25 Jan. 1999 under the deposition number DSM 12648.

In one embodiment of the present invention, the cellulase is selected from the group comprising:

a) an endo-beta-1,4-glucanase enzyme having a sequence of at least 60% identity to the amino acid sequence of position 1 to position 773 of SEQ ID NO:1 as described in WO 02099091 (corresponding to SEQ ID NO: 2 of WO 02099091). Preferably the endo-beta-1,4-glucanase enzyme has a sequence of at least 70% identity to the amino acid sequence of position 1 to position 773 of SEQ ID NO:1, more preferred at least 75%, or at least 80% or even more preferred at least 85%, or at least 90%, preferably at least 94%, 95% or 96% or at least 97% or more preferred at least 98% or 99% or most preferred 100% identity to the amino acid sequence of position 1 to position 773 of SEQ ID NO:1 or to a fragment thereof that has endo-glucanase activity.

A fragment of position 1 to position 773 of SEQ ID NO:1 is a polypeptide, which have one or more amino acids deleted from the amino and/or carboxyl terminus of this amino acid sequence.

One of such enzymes is commercially available under the tradename Celluclean® from Novozymes A/S;

b) an endo-beta-1,4-glucanase enzyme having the amino acid sequence of positions 1 to 773 in SEQ ID NO:1;

c) an endo-beta-1,4-glucanase enzyme having a sequence of at least 60% identity to the amino acid sequence of position 1 to position 284 of SEQ ID NO:2 as described as SEQ ID NO:2 in WO 91/17243. Preferably the endo-beta-1,4-glucanase enzyme has a sequence of at least 70% identity to the amino acid sequence of position 1 to position 284 of SEQ ID NO:2, more preferred at least 75%, or at least 80% or even more preferred at least 85%, or at least 90%, preferably at least 94%, 95% or 96% or at least 97% or more preferred at least 98% or 99% or most preferred 100% identity to the amino acid sequence of position 1 to position 284 of SEQ ID NO:2 or a fragment thereof that has endo-glucanase activity, where a fragment of position 1 to position 284 of SEQ ID NO:2 is a polypeptide, which have one or more amino acids deleted from the amino and/or carboxyl terminus of this amino acid sequence. One of such enzymes is commercially available under the tradename Carezyme® from Novozymes A/S;

d) the endo-beta-1,4-glucanase enzyme having the amino acid sequence of positions 1 to 284 in SEQ ID NO:2;

e) an endo-beta-1,4-glucanase enzyme having a sequence of at least 60% identity to the amino acid sequence of position 1 to position 415 of SEQ ID NO:3 as described in WO 95/24471. Preferably the endo-beta-1,4-glucanase enzyme has a sequence of at least 70% identity to the amino acid sequence of position 1 to position 415 of SEQ ID NO:3, more preferred at least 75%, or at least 80% or even more preferred at least 85%, or at least 90%, preferably at least 94%, 95% or 96% or at least 97% or more preferred at least 98% or 99% or most preferred 100% identity to the amino acid sequence of position 1 to position 415 of SEQ ID NO:3 or a fragment thereof that has endo-glucanase activity, where a fragment of position 1 to position 415 of SEQ ID NO:3 is a polypeptide, which have one or more amino acids deleted from the amino and/or carboxyl terminus of this amino acid sequence;

f) the endo-beta-1,4-glucanase enzyme having the amino acid sequence of positions 1 to 415 in SEQ ID NO:3;

g) an endo-beta-1,4-glucanase enzyme having a sequence of at least 60% identity to the amino acid sequence of position 1 to position 278 of SEQ ID NO:4. Preferably the endo-beta-1,4-glucanase enzyme has a sequence of at least 70% identity to the amino acid sequence of position 1 to position 278 of SEQ ID NO:4, more preferred at least 75%, or at least 80% or even more preferred at least 85%, or at least 90%, preferably at least 94%, 95% or 96% or at least 97% or more preferred at least 98% or 99% or most preferred 100% identity to the amino acid sequence of position 1 to position 278 of SEQ ID NO:4 or a fragment thereof that has endo-glucanase activity, where a fragment of position 1 to position 278 of SEQ ID NO:4 is a polypeptide, which have one or more amino acids deleted from the amino and/or carboxyl terminus of this amino acid sequence. One of such enzymes is commercially available under the tradename Carezyme Premium° from Novozymes A/S;

h) the endo-beta-1,4-glucanase enzyme having the amino acid sequence of positions 1 to 278 in SEQ ID NO:4;

i) the endoglucanase enzymes described in EP1350843A published by Kao corporation on Oct. 8, 2003. Please refer to the detailed description [0011] to [0039] and examples 1 to 4 [0067] to [0077] for a detailed description of the enzymes and its production. The cellulase variants are obtained by substituting the amino acid residue of a cellulase having an amino acid sequence exhibiting at least 60%, such as 70%, preferably 75% or 80% or 90%, or preferably 95% or 96% or 97%, more preferably 98%, or 99% and even 100% identity with the amino acid sequence represented by SEQ. ID NO:5 (Corresponding to SEQ. ID NO:1 in EP1350843 on pages 11-13) at (a) position 10, (b) position 16, (c) position 22, (d) position 33, (e) position 39, (f) position 76, (g) position 109, (h) position 242, (i) position 263, (j) position 308, (k) position 462, (l) position 466, (m) position 468, (n) position 552, (o) position 564, or (p) position 608 in SEQ ID NO:5 or at a position corresponding thereto with another amino acid residue. Examples of the “cellulase having the amino acid sequence represented by SEQ. ID NO:5” include Egl-237 (derived from Bacillus sp. strain KSM-S237 (FERM BP-7875), Hakamada, et al., Biosci. Biotechnol. Biochem., 64, 2281-2289, 2000). Examples of the “cellulase having an amino acid sequence exhibiting at least 90 percent homology with the amino acid sequence represented by SEQ. ID NO:5” include cellulases having an amino acid sequence exhibiting preferably at least 95 percent homology, more preferably at least 98 percent homology, with the amino acid sequence represented by SEQ. ID NO:5. Specific examples include cellulases derived from Bacillus sp. strain 1139 (Egl-1139) (Fukumori, et al., J. Gen. Microbiol., 132, 2329-2335) (91.4 homology), cellulases derived from Bacillus sp. strain KSM-64 (Egl-64) (Sumitomo, et al., Biosci. Biotechnol. Biochem., 56, 872-877, 1992) (homology: 91.9%), and cellulase derived from Bacillus sp. strain KSM-N131 (Egl-N131b) (Japanese Patent Application No. 2000-47237) (homology: 95.0%).

The amino acid is preferably substituted by: glutamine, alanine, proline or methionine, especially glutamine is preferred at position (a), asparagine or arginine, especially asparagine is preferred at position (b), proline is preferred at position (c), histidine is preferred at position (d), alanine, threonine or tyrosine, especially alanine is preferred at position (e), histidine, methionine, valine, threonine or alanine, especially histidine is preferred at position (f), isoleucine, leucine, serine or valine, especially isoleucine is preferred at position (g), alanine, phenylalanine, valine, serine, aspartic acid, glutamic acid, leucine, isoleucine, tyrosine, threonine, methionine or glycine, especially alanine, phenylalanine or serine is preferred at position (h), isoleucine, leucine, proline or valine, especially isoleucine is preferred at position (i), alanine, serine, glycine or valine, especially alanine is preferred at position (j), threonine, leucine, phenylalanine or arginine, especially threonine is preferred at position (k), leucine, alanine or serine, especially leucine is preferred at position (l), alanine, aspartic acid, glycine or lysine, especially alanine is preferred at position (m), methionine is preferred at position (n), valine, threonine or leucine, especially valine is preferred at position (o) and isoleucine or arginine, especially isoleucine is preferred at position (p).

The “amino acid residue at a position corresponding thereto” can be identified by comparing amino acid sequences by using known algorithm, for example, that of Lipman-Pearson's method, and giving a maximum similarity score to the multiple regions of similarity in the amino acid sequence of each cellulase. The position of the homologous amino acid residue in the sequence of each cellulase can be determined, irrespective of insertion or depletion existing in the amino acid sequence, by aligning the amino acid sequence of the cellulase in such manner (FIG. 1 of EP 1 350 843). It is presumed that the homologous position exists at the three-dimensionally same position and it brings about similar effects with regard to a specific function of the target cellulase.

With regard to another cellulase having an amino acid sequence exhibiting at least 90 percent homology with SEQ. ID NO:5, specific examples of the positions corresponding to (a) position 10, (b), position 16, (c) position 22, (d) position 33, (e) position 39, (f) position 76, (g) position 109, (h) position 242, (i) position 263, (j) position 308, (k) position 462, (l) position 466, (m) position 468, (n) position 552, (o) position 564 and (p) position 608 of the cellulase (Egl-237) represented by SEQ. ID NO: 5 and amino acid residues at these positions will be shown below:

| | Egl-237 | Egl-1139 | Egl-64 | Egl-N131b |
|---|---|---|---|---|
| (a) | 10Leu | 10Leu | 10Leu | 10Leu |
| (b) | 16Ile | 16Ile | 16Ile | Nothing corresponding thereto |
| (c) | 22Ser | 22Ser | 22Ser | Nothing corresponding thereto |
| (d) | 33Asn | 33Asn | 33Asn | 19Asn |
| (e) | 39Phe | 39Phe | 39Phe | 25Phe |
| (f) | 76Ile | 76Ile | 76Ile | 62Ile |
| (g) | 109Met | 109Met | 109Met | 95Met |
| (h) | 242Gln | 242Gln | 242Gln | 228Gln |
| (i) | 263Phe | 263Phe | 263Phe | 249Phe |
| (j) | 308Thr | 308Thr | 308Thr | 294Thr |
| (k) | 462Asn | 461Asn | 461Asn | 448Asn |
| (l) | 466Lys | 465Lys | 465Lys | 452Lys |
| (m) | 468Val | 467Val | 467Val | 454Val |
| (n) | 552Ile | 550Ile | 550Ile | 538Ile |
| (o) | 564Ile | 562Ile | 562Ile | 550Ile |
| (p) | 608Ser | 606Ser | 606Ser | 594Ser |

j) the cellulase K described in EP 265 832A published by Kao on May 4, 1988. Please refer to the description page 4, line 35 to page 12, line 22 and examples 1 and 2 on page 19 for a detailed description of the enzyme and its production. The cellulase K has the following physical and chemical properties:

(1) Activity: Having a Cx enzymatic activity of acting on carboxymethyl cellulose along with a weak C₁ enzymatic activity and a weak beta-glucoxidase activity;

(2) Specificity on Substrates: Acting on carboxymethyl cellulose(CMC), crystalline cellulose, Avicell, cellobiose, and p-nitrophenyl cellobioside(PNPC);

(3) Having a working pH in the range of 4 to 12 and an optimum pH in the range of 9 to 10;

(4) Having stable pH values of 4.5 to 10.5 and 6.8 to 10 when allowed to stand at 40 degrees centigrade for 10 minutes and 30 minutes, respectively;

(5) Working in a wide temperature range of from 10 to 65 degrees centigrade with an optimum temperature being recognized at about 40 degrees C.;

(6) Influences of chelating agents: The activity not impeded with ethylenediamine tetraacetic acid (EDTA), ethyleneglycol-bis-(beta-aminoethylether) N,N,N′,N″-tetraacetic acid (EGTA), N,N-bis(carboxymethyl)glycine (nitrilotriacetic acid) (NTA), sodium tripolyphosphate (STPP) and zeolite;

(7) Influences of surface active agents: Undergoing little inhibition of activity by means of surface active agents such as sodium linear alkylbenzenesulfonates (LAS), sodium alkylsulfates (AS), sodium polyoxyethylene alkylsulfates (ES), sodium alphaolefinsulfonates (AOS), sodium alpha-sulfonated aliphatic acid esters (alpha-SFE), sodium alkylsulfonates (SAS), polyoxyethylene secondary alkyl ethers, fatty acid salts (sodium salts), and dimethyldialkylammonium chloride;

(8) Having a strong resistance to proteinases; and

(9) Molecular weight (determined by gel chromatography): Having a maximum peak at 180,000 plus or minus 10,000.

Preferably such enzyme is obtained by isolation from a culture product of Bacillus sp KSM-635. Cellulase K is commercially available by the Kao Corporation: e.g. the cellulase preparation Eg-X known as KAC(R) being a mixture of E-H and E-L both from Bacillus sp. KSM-635 bacterium. Cellulases E-H and E-L have been described in S. Ito, Extremophiles, 1997, v1, 61-66 and in S. Ito et al, Agric Biol Chem, 1989, v53, 1275-1278.

k) the bacterial endoglucanases described in EP 271 004A published by Kao on Jun. 15, 1988. Please refer to the description page 9, line 15 to page 23, line 17 and page 31, line 1 to page 33, line 17 for a detailed description of the enzymes and its production. Those are:

Cellulase K-534 from KSM 534, FERM BP 1508,

Cellulase K-539 from KSM 539, FERM BP 1509,

Cellulase K-577 from KSM 577, FERM BP 1510,

Cellulase K-521 from KSM 521, FERM BP 1507,

Cellulase K-580 from KSM 580, FERM BP 1511,

Cellulase K-588 from KSM 588, FERM BP 1513,

Cellulase K-597 from KSM 597, FERM BP 1514,

Cellulase K-522 from KSM 522, FERM BP 1512,

Cellulase E-II from KSM 522, FERM BP 1512,

Cellulase E-III from KSM 522, FERM BP 1512.

Cellulase K-344 from KSM 344, FERM BP 1506, and

Cellulase K-425 from KSM 425, FERM BP 1505.

l) the endoglucanases derived from Bacillus species KSM-N described in JP2005287441A, published by Kao on the Oct. 20, 2005, Please refer to the description page 4, line 39 to page 10, line 14 for a detailed description of the enzymes and its production. Examples of such endoglucanases are:

Cellulase Egl-546H from Bacillus sp. KSM-N546

Cellulase Egl-115 from Bacillus sp. KSM-N115

Cellulase Egl-145 from Bacillus sp. KSM-N145

Cellulase Egl-659 from Bacillus sp. KSM-N659

Cellulase Egl-640 from Bacillus sp. KSM-N440;

m) and mixtures of a)-l) disclosed enzymes.

In one embodiment of the invention the cellulase is Ecostone or Biotouch. In one embodiment the cellulase is selected from the group consisting of Ecostone HPP 5000, Ecostone L900, Ecostone HPP 1500, Ecostone HPL1800, Ecostone HPL1900, Ecostone HPP 1500, Ecostone HPL1800, Ecostone HPL1900, Ecostone F7, Ecostone F5, Ecostone CXP500, Ecostone C1000, Ecostone C1, Ecostone C10, Biotouch C800, Biotouch OSB 7, Biotouch OSB-N1, Ecostone L900, Ecostone HPP 5000, Ecostone HPL1800, Biotouch XC300, Biotouch C700, Biotouch C39, Biotouch C37 and Biotouch C30 available from AB enzymes.

In one embodiment the cellulase is selected from the group consisting of:
an endo-beta-1,4-glucanase enzyme having a sequence of at least 60% identity to the amino acid sequence of position 1 to position 773 of SEQ ID NO:1; and
the endo-beta-1,4-glucanase enzyme having the amino acid sequence of positions 1 to 773 in SEQ ID NO:1;

In one embodiment the cellulase is selected from the group consisting of:
an endo-beta-1,4-glucanase enzyme having a sequence of at least 60% identity to the amino acid sequence of position 1 to position 415 of SEQ ID NO:3; and
the endo-beta-1,4-glucanase enzyme having the amino acid sequence of positions 1 to 415 in SEQ ID NO:3;

Also encompassed in the present invention are variants of the above described enzymes obtained by various techniques known by persons skilled in the art such as directed evolution.

In one embodiment of the invention, the optical brightener is selected from the group comprising benzenesulfonic acid, 2,2′-(1,2-ethenediyl)bis[5-[4-(4-morpholinyl)-6-(phenylamino)-1,3,5-triazin-2-yl]amino]-, disodium salt; 2,2′-([1,1′-biphenyl]-4,4′-diyldi-2,1-ethenediyl)bis-, disodium salt; diaminostilbene-sulphonic acid derivative including sodium salts of: 4,4′-bis-(2-diethanolamino-4-anilino-s-triazin-6-ylamino) stilbene-2,2′-disulphonate; 4,4′-bis-(2,4-dianilino-s-triazin-6-ylamino) stilbene-2.2′-disulphonate; 4,4′-bis-(2-anilino-4(N-methyl-N-2-hydroxy-ethylamino)-s-triazin-6-ylamino) stilbene-2,2′-disulphonate, 4,4′-bis-(4-phenyl-2,1,3-triazol-2-yl)stilbene-2,2′-disulphonate; 4,4′-bis-(2-anilino-4(1-methyl-2-hydroxy-ethylamino)-s-triazin-6-ylamino) stilbene-2,2′-disulphonate and/or 2-(stilbyl-4″-naptho-1.,2′:4,5)-1,2,3-trizole-2″-sulphonate; or 4,4′-bis-(2-morpholino-4 anilino-s-triazin-6-ylamino) stilbene disulphonate or 2,2′-bis-(phenyl-styryl) disulphonate, or 4.4′-bis-(sulfostyryl)-biphenyl disodium salt or mixtures hereof.

In one embodiment the optical brightener is 4.4′-bis-(sulfostyryl)-biphenyl disodium salt.

In one embodiment of the invention the cellulase maintains the whiteness of the textile, ie. the ΔY value is zero.

In one embodiment of the invention the cellulase improves the whiteness of the textile. In one embodiment the ΔY value is at least 0.3. In one embodiment the ΔY value is at least 0.5. In one embodiment the ΔY value is at least 0.8. In one embodiment the ΔY value is at least 1. In one embodiment the ΔY value is at least 1.5. In one embodiment the ΔY value is at least 2.

In one embodiment of the invention the cellulase is used in a detergent composition detergent composition which further comprises an enzyme selected from the group of protease, lipase, cutinase, amylase, carbohydrase, pectinase, mannanase, arabinase, galactanase, xylanase and oxidase.

In one embodiment the protease is Savinase and the amylase is Stainzyme.

In one embodiment the cellulase is used in a liquid detergent composition. In one embodiment the cellulase is used in a powder detergent composition. The detergent composition may comprise components selected from the group consisting of surfactants, builders, co-builders, polymers, hydrotropes, anti-foaming agents and fabric hueing agents.

In one embodiment the method for maintaining or improving the whiteness of a textile the textile is exposed to the wash liquid more than one time. In one embodiment the textile is exposed to the wash liquid several times such as more than two times, more than three times, more than four times, more than five times, more than six times, more than seven times, more than eight times, more than nine times, more than ten times, more than fifteen times or more than twenty times.

In one embodiment of the invention the textile is selected from the group consisting of: cellulose based textiles and textiles which partly is made of cellulose based textile. In one embodiment the textile is cotton or a cotton blend. In one embodiment, the cellulase of the reformulated composition is comprised at a level of between 0.1 and 600 ECU/L wash liquid, preferably between 0.2 and 500, such as between 0.25 and 400 or between 0.3 and 300, even more preferred between 0.5 and 100 or most preferred between 2 and 50, such as between 3 and 30 ECU/L wash liquid.

In another embodiment, the cellulase of the reformulated composition is comprised at a level of at most 600 ECU/L wash liquid, such as at most 500 ECU/L, or at most 400 ECU/L, or 300 ECU/L or 200 ECU/L or even at most 100 ECU/L or at most 50 ECU/L or at most 30 ECU/L or at most 20 ECU/L or at a level of at most 10 ECU/L or even at a level of at most 5 ECU/L, or at most 4 or 3 or 2 or 1 ECU/L wash liquid.

In one embodiment, the cellulase of the reformulated composition is comprised at a level of at least 0.1 ECU/L wash liquid, such as at least 0.2 or 0.3, or 0.4, or 0.5, or at least 1.0 ECU/L wash liquid, or at least 1.5 or 2.0 or at least 3.0 ECU/L wash liquid, or even at a level of at least 5.0 ECU/L wash liquid.

In yet an embodiment of the invention, the cellulase of the reformulated composition is comprised at a level of between 0.5 and 100 ECU/g detergent composition, preferably between 1 and 75, or even more preferred between 1.35 and 50 ECU/g detergent composition.

In another embodiment of the invention, the cellulase of the reformulated composition is comprised at a level of at most 200 ECU/g detergent composition, preferably at most 100 ECU/g detergent composition or even more preferred at most 75 ECU/g detergent composition, such as at most 50 or 40 or 30 or at most 20 or even at most 10 ECU/g detergent composition.

In yet an embodiment of the invention, the cellulase of the reformulated composition is comprised at a level of at least 0.3 ECU/g detergent composition, such as at least 0.4, or 0.5 or at least 1.0 or at least 1.1, or at least 1.2, or at least 1.3 or at least 1.35 or at least 1.4 ECU/g detergent composition, such as at least 1.5, or 2.0 or 3 or at least 4 at least or at least 5 ECU/g detergent composition, such as at least 10 or at least 20 ECU/g detergent composition.

In one embodiment of the invention the detergent comprises a cellulase in an amount of 0.1-100 ECU/g detergent composition, 0.2-50 ECU/g detergent composition, 0.3-20 ECU/g detergent composition, 1-10 ECU/g detergent composition or 1.35-9 ECU/g detergent composition.

In one embodiment of the invention the detergent composition comprises a cellulase in an amount of 1-200 ECU/g detergent composition, 2-100 ECU/g detergent composition, 3-50 ECU/g detergent composition, 5-30 ECU/g detergent composition or 7.5-30 ECU/g detergent composition.

In yet an embodiment of the invention, the cellulase of the detergent composition is comprised at a level of between 0.5 and 100 ECU/g detergent composition, preferably between 1 and 75, or even more preferred between 1.35 and 50 ECU/g detergent composition.

In another embodiment of the invention, the cellulase of the detergent composition is comprised at a level of at most 200 ECU/g detergent composition, preferably at most 100 ECU/g detergent composition or even more preferred at most 75 ECU/g detergent composition, such as at most 50 or 40 or 30 or at most 20 or even at most 10 ECU/g detergent composition.

In yet an embodiment of the invention, the cellulase of the detergent composition is comprised at a level of at least 0.3 ECU/g detergent composition, such as at least 0.4, or 0.5 or at least 1.0 or at least 1.1, or at least 1.2, or at least 1.3 or at least 1.35 or at least 1.4 ECU/g detergent composition, such as at least 1.5, or 2.0 or 3 or at least 4 at least or at least 5 ECU/g detergent composition, such as at least 10 or at least 20 ECU/g detergent composition.

In one embodiment of the invention the cellulase is used in an amount of 0.1-100 ECU/g detergent composition, 0.2-50 ECU/g detergent composition, 0.3-20 ECU/g detergent composition, 1-10 ECU/g detergent composition or 1.35-9 ECU/g detergent composition.

In one embodiment of the invention the cellulase is used in an amount of 1-200 ECU/g detergent composition, 2-100 ECU/g detergent composition, 3-50 ECU/g detergent composition, 5-30 ECU/g detergent composition or 7.5-30 ECU/g detergent composition.

In yet an embodiment of the invention, the cellulase is used at a level of between 0.5 and 100 ECU/g detergent composition, preferably between 1 and 75, or even more preferred between 1.35 and 50 ECU/g detergent composition.

In another embodiment of the invention, the cellulase is used at a level of at most 200 ECU/g detergent composition, preferably at most 100 ECU/g detergent composition or even more preferred at most 75 ECU/g detergent composition, such as at most 50 or 40 or 30 or at most 20 or even at most 10 ECU/g detergent composition.

In yet an embodiment of the invention, the cellulase is used at a level of at least 0.3 ECU/g detergent composition, such as at least 0.4, or 0.5 or at least 1.0 or at least 1.1, or at least 1.2, or at least 1.3 or at least 1.35 or at least 1.4 ECU/g detergent composition, such as at least 1.5, or 2.0 or 3 or at least 4 at least or at least 5 ECU/g detergent composition, such as at least 10 or at least 20 ECU/g detergent composition.

In one embodiment of the invention, the amount of optical brightener in the reformulated composition compared to the first detergent composition is reduced by at least 30%, such as preferably by at least 40% or more preferred by at least 50%, or by at least 60%, or even more preferred by at least 70%, or most preferred by at least 80% or even by at least 90%.

It is an advantage to reduce the amount of optical brightener for several reasons. One reason is that the optical brighteners may cause allergy. The inventor has found that the reduction in the obtained Y-value of textile treated with a detergent composition having a reduced amount of optical brighter may be fully compensated or even improved by addition of a cellulase of the invention.

The invention further concerns a detergent composition comprising a. an optical brightener, at a level of at most 0.75% by weight of the composition, a cellulase and from 0.1 percent to 60 percent by weight of surfactant.

The optical brightener may be present at most 0.5% by weight of the composition, such as at most 0.4% by weight of the composition, at the most 0.3% by weight of the composition, at the most 0.26% by weight of the composition, at the most 0.2% by weight of the composition, at the most 0.15% by weight of the composition, at the most 0.1% by weight of the composition, at the most 0.08% by weight of the composition, at the most 0.065% by weight of the composition, at the most 0.05% by weight of the composition, at most 0.04% by weight of the composition, at the most 0.03% by weight of the composition, at the most 0.02% by weight of the composition, at the most 0.01% by weight of the composition or at the most 0.005% by weight of the composition,

The invention further relates to a detergent composition comprising an optical brightener and a cellulase and from 0.1 percent to 60 percent by weight of surfactant, wherein the optical brightener is comprised at a level of at most 0.75% by weight of the composition, preferably at most 0.5% by weight of the composition, such as at most 0.4, or 0.3, or 0.2, or 0.1, or 0.05%, or at most 0.04%, or 0.03 or 0.02 or 0.01 or 0.005% by weight of the composition.

In one embodiment, the cellulase is present in an amount of at least 0.5 ECU/g of the composition.

In preferred embodiments of the present invention, the cellulase to be included in the detergent composition exhibits endo-beta-1,4-glucanase activity. The cellulase may preferably be selected from the group as described above.

In yet an embodiment of the invention, the cellulase of the detergent composition is comprised at a level of between 0.5 and 100 ECU/g of detergent composition, preferably between 1 and 75, or even more preferred between 1.35 and 50 ECU/g of detergent composition.

In another embodiment of the invention, the cellulase of the detergent composition is comprised at a level of at most 200 ECU/g of detergent composition, preferably at most 100 ECU/g of detergent composition or even more preferred at most 75 ECU/g of detergent composition, such as at most 50 or 40 or 30 or at most 20 or even at most 10 ECU/g of detergent composition.

In yet an embodiment of the invention, the cellulase of the reformulated composition is comprised at a level of at least 1 ECU/g of detergent composition, at least 1.1, or at least 1.2, or at least 1.3 or at least 1.35 or at least 1.4 ECU/g of detergent composition, such as at least 1.5, or 2.0 or 3 or at least 4 at least or at least 5 ECU/g of detergent composition, such as at least 10 or at least 20 ECU/g of detergent composition.

The enzyme(s) of the detergent composition of the invention may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in, for example, WO92/19709 and WO92/19708.

In one embodiment the optical brighter of the present invention may be selected from the group comprising diaminostilbene-sulphonic acid derivatives, diarylpyrazoline derivatives, benzenesulfonic acid derivatives and bisphenyl-distyryl derivatives or mixtures hereof.

In particular, the optical brighter may be selected from the group comprising benzenesulfonic acid, 2,2′-(1,2-ethenediyl)bis[5-[4-(4-morpholinyl)-6-(phenylamino)-1,3,5-triazin-2-yl]amino]-, disodium salt, benzenesulfonic acid, 2,2′-([1,1′-biphenyl]-4,4′-diyldi-2,1-ethenediyl)bis-, disodium salt; (also known as Distyrylbiphenylsulfonate), the diaminostilbene-sulphonic acid derivative type of optical brighteners that include the sodium salts of: 4,4′-bis-(2-diethanolamino-4-anilino-s-triazin-6-ylamino) stilbene-2,2′-disulphonate; 4,4′-bis-(2,4-dianilino-s-triazin-6-ylamino) stilbene-2.2′-disulphonate; 4,4′-bis-(2-anilino-4(N-methyl-N-2-hydroxy-ethylamino)-s-triazin-6-ylamino) stilbene-2,2′-disulphonate, 4,4′-bis-(4-phenyl-2,1,3-triazol-2-yl)stilbene-2,2′-disulphonate; 4,4′-bis-(2-anilino-4((1-methyl-2-hydroxy-ethylamino)-s-triazin-6-yl)amino) stilbene-2,2′-disulphonate and/or 2-(stilbyl-4″-naptho-1.,2′:4,5)-1,2,3-trizole-2″-sulphonate or mixtures hereof.

In other embodiments of the invention preferred optical brighteners are Tinopal DMS or Tinopal CBS or Tinopal CBS-X available from BASF. Tinopal DMS is the disodium salt of 4,4′-bis-((2-morpholino-4 anilino-s-triazin-6-yl)amino) stilbene disulphonate. Tinopal CBS is the disodium salt of 2,2′-bis-(phenyl-styryl) disulphonate. Tinopal CBS-X is a 4.4′-bis-(sulfostyryl)-biphenyl disodium salt also known as Disodium Distyrylbiphenyl Disulfonate. Also preferred are the commercially available Parawhite KX, supplied by Paramount Minerals and Chemicals, Mumbai, India. Other fluorescers suitable for use in the invention include the 1-3-diaryl pyrazolines and the 7-alkylaminocoumarins.

Other suitable optical brighteners of the invention are; Disodium Anilinomorpholinotriazinylaminostilbenesulfonate; Disodium 4,4′-bis[(4-anilino-6-morpholino-1,3,5-triazin-2-yl)amino]-stilbene-2,2′-disulfonate also known as “FWA-1”; Dimorpholinopyridazinone and DASC-4 which is disodium 2-[(E)-2-[4-[[4-anilino-6-[2-hydroxyethyl(methyl)amino]-1,3,5-triazin-2-yl]amino]-2-sulfonatophenyl]ethenyl]-5-[[4-[2-hydroxyethyl(methyl)amino]-6-phenyl-1,3,5-triazin-2-yl]amino]benzenesulfonate.

In a preferred embodiment, the optical brightener is FWA-1, Tinopal DMS, Tinopal CBS or Tinopal CBS-X. Accordingly, the invention relates to a detergent composition comprising an optical brightener selected from the group comprising FWA-1, Tinopal DMS, Tinopal CBS and Tinopal CBS-X, the optical brightener comprised at a level of at most 0.75% by weight of the composition, and a cellulase as disclosed in SEQ ID NO 1 and from 0.1 percent to 60 percent by weight of surfactant.

In yet another embodiment, the invention relates to a detergent composition comprising an optical brightener selected from the group comprising FWA-1, Tinopal DMS, Tinopal CBS and Tinopal CBS-X, the optical brightener comprised at a level of at most 0.75% by weight of the composition, and a cellulase as disclosed in SEQ ID NO 2 and from 0.1 percent to 60 percent by weight of surfactant.

In one embodiment the cellulase is selected from the group consisting of:
an endo-beta-1,4-glucanase enzyme having a sequence of at least 60% identity to the amino acid sequence of position 1 to position 773 of SEQ ID NO:1; and
the endo-beta-1,4-glucanase enzyme having the amino acid sequence of positions 1 to 773 in SEQ ID NO:1;
   and the optical brightener is 4.4′-bis-(sulfostyryl)-biphenyl disodium salt

In one embodiment the cellulase is selected from the group consisting of:
an endo-beta-1,4-glucanase enzyme having a sequence of at least 60% identity to the amino acid sequence of position 1 to position 415 of SEQ ID NO:3; and
the endo-beta-1,4-glucanase enzyme having the amino acid sequence of positions 1 to 415 in SEQ ID NO:3;
   and the optical brightener is 4.4′-bis-(sulfostyryl)-biphenyl disodium salt

In another preferred embodiment, the invention relates to a detergent composition comprising an optical brightener selected from the group comprising FWA-1, Tinopal DMS, Tinopal CBS and Tinopal CBS-X, the optical brightener comprised at a level of at most 0.75% by weight of the composition, and a cellulase as disclosed in SEQ ID NO 3 and from 0.1 percent to 60 percent by weight of surfactant.

In another preferred embodiment, the invention relates to a detergent composition comprising an optical brightener selected from the group comprising FWA-1, Tinopal DMS, Tinopal CBS and Tinopal CBS-X, the optical brightener comprised at a level of at most 0.75% by weight of the composition, and a cellulase as disclosed in SEQ ID NO 4 and from 0.1 percent to 60 percent by weight of surfactant.

In another preferred embodiment, the invention relates to a detergent composition comprising an optical brightener selected from the group comprising FWA-1, Tinopal DMS, Tinopal CBS and Tinopal CBS-X, the optical brightener comprised at a level of at most 0.75% by weight of the composition, and a cellulase as disclosed in SEQ ID NO 5 and from 0.1 percent to 60 percent by weight of surfactant.

Naturally, other not specifically mentioned acids or salts of all of the above mentioned optical brighteners are also encompassed by this invention.

In another embodiment the invention relates to a method of washing a fabric comprising a step of contacting said fabric with the composition as described herein, then optionally washing and/or rinsing said surface or fabric.

In another embodiment the invention relates to the use of a cellulase as described herein for reducing the amount of optical brighteners in detergent compositions.

### Surfactants

The detergent composition may comprise one or more surfactants, which may be anionic and/or cationic and/or non-ionic and/or semi-polar and/or zwitterionic, or a mixture thereof. In a particular embodiment, the detergent composition includes a mixture of one or more nonionic surfactants and one or more anionic surfactants. The surfactant(s) is typically present at a level of from about 0.1% to 60% by weight, such as about 1% to about 40%, or about 3% to about 20%, or about 3% to about 10%. The surfactant(s) is chosen based on the desired cleaning application, and includes any conventional surfactant(s) known in the art. Any surfactant known in the art for use in detergents may be utilized.

When included therein the detergent will usually contain from about 1% to about 40% by weight, such as from about 5% to about 30%, including from about 5% to about 15%, or from about 20% to about 25% of an anionic surfactant. Non-limiting examples of anionic surfactants include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or soap, and combinations thereof.

When included therein the detergent will usually contain from about 1% to about 40% by weight of a cationic surfactant. Non-limiting examples of cationic surfactants include alklydimethylehanolamine quat (ADMEAQ), cetyltrimethylammonium bromide (CTAB), dimethyldistearylammonium chloride (DSDMAC), and alkylbenzyldimethylammonium, and combinations thereof, Alkyl quaternary ammonium compounds, Alkoxylated quaternary ammonium (AQA).

When included therein the detergent will usually contain from about 0.2% to about 60% by weight of a non-ionic surfactant, for example from about 0.3 to about 40%, such as from about 0.5% to about 30%, in particular from about 1% to about 20%, from about 3% to about 10%, such as from about 3% to about 5%, or from about 8% to about 12%. Non-limiting examples of non-ionic surfactants include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamide (PFAM), polyhydroxy alkyl fatty acid amides, or N-acyl N-alkyl derivatives of glucosamine (glucamides, GA, or fatty acid glucamide, FAGA), as well as products available under the trade names SPAN and TWEEN, and combinations thereof.

When included therein the detergent will usually contain from about 1% to about 40% by weight of a semipolar surfactant. Non-limiting examples of semipolar surfactants include amine oxides (AO) such as alkyldimethylamineoxide, N-(coco alkyl)-N,N-dimethylamine oxide and N-(tallow-alkyl)-N,N-bis(2-hydroxyethyl)amine oxide, fatty acid alkanolamides and ethoxylated fatty acid alkanolamides, and combinations thereof.

When included therein the detergent will usually contain from about 1% to about 40% by weight of a zwitterionic surfactant. Non-limiting examples of zwitterionic surfactants include betaine, alkyldimethylbetaine, and sulfobetaine, and combinations thereof.

### Hydrotropes

A hydrotrope is a compound that solubilises hydrophobic compounds in aqueous solutions (or oppositely, polar substances in a non-polar environment). Typically, hydrotropes have both hydrophilic and a hydrophobic character (so-called amphiphilic properties as known from surfactants); however the molecular structure of hydrotropes generally do not favor spontaneous self-aggregation, see e.g. review by Hodgdon and Kaler (2007), Current Opinion in Colloid & Interface Science 12: 121-128. Hydrotropes do not display a critical concentration above which self-aggregation occurs as found for surfactants and lipids forming miceller, lamellar or other well defined meso-phases. Instead, many hydrotropes show a continuous-type aggregation process where the sizes of aggregates grow as concentration increases. However, many hydrotropes alter the phase behavior, stability, and colloidal properties of systems containing substances of polar and non-polar character, including mixtures of water, oil, surfactants, and polymers. Hydrotropes are classically used across industries from pharma, personal care, food, to technical applications. Use of hydrotropes in detergent compositions allow for example more concentrated formulations of surfactants (as in the process of compacting liquid detergents by removing water) without inducing undesired phenomena such as phase separation or high viscosity.

The detergent may contain 0-5% by weight, such as about 0.5 to about 5%, or about 3% to about 5%, of a hydrotrope. Any hydrotrope known in the art for use in detergents may be utilized. Non-limiting examples of hydrotropes include sodium benzene sulfonate, sodium p-toluene sulfonates (STS), sodium xylene sulfonates (SXS), sodium cumene sulfonates (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

### Builders and Co-Builders

The detergent composition may contain about 0-65% by weight of a detergent builder or co-builder, or a mixture thereof. In a dish wash detergent, the level of builder is typically 40-65%, particularly 50-65%. The builder and/or co-builder may particularly be a chelating agent that forms water-soluble complexes with Ca²⁺ and Mg²⁺. Any builder and/or co-builder known in the art for use in laundry detergents may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), disilicates, ethanolamines such as 2-aminoethan-1-ol (MEA), iminodiethanol (DEA) and 2,2′,2″-nitrilotriethanol (TEA), and carboxymethylinulin (CMI), and combinations thereof.

The detergent composition may also contain 0-65% by weight of a detergent co-builder, or a mixture thereof. The detergent composition may include include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), etheylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diylbis(phosphonic acid) (HEDP), ethylenediaminetetrakis(methylene)tetrakis(phosphonic acid) (EDTMPA), diethylenetriaminepentakis(methylene)pentakis(phosphonic acid) (DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N, N-diacetic acid (SLDA), taurine-N, N-diacetic acid (TUDA) and sulfomethyl-N,N-diacetic acid (SMDA), N-(hydroxyethyl)-ethylidenediaminetriacetate (HEDTA), diethanolglycine (DEG), Diethylenetriamine Penta (Methylene Phosphonic acid) (DTPMP), aminotris(methylenephosphonic acid) (ATMP), and combinations and salts thereof. Further exemplary builders and/or co-builders are described in, e.g., WO 09/102854, U.S. Pat. No. 5,977,053.

### Bleaching Systems

The detergent may contain 0-40% by weight, such as about 5% to about 25%, of a bleaching system. Any bleaching system known in the art for use in laundry detergents may be utilized. Suitable bleaching system components include bleaching catalysts, photobleaches, bleach activators, sources of hydrogen peroxide such as sodium percarbonate and sodium perborates, preformed peracids and mixtures thereof. Suitable preformed peracids include, but are not limited to, peroxycarboxylic acids and salts, percarbonic acids and salts, perimidic acids and salts, peroxymonosulfuric acids and salts, for example, Oxone (R), and mixtures thereof. Non-limiting examples of bleaching systems include peroxide-based bleaching systems, which may comprise, for example, an inorganic salt, including alkali metal salts such as sodium salts of perborate (usually mono- or tetra-hydrate), percarbonate, persulfate, perphosphate, persilicate salts, in combination with a peracid-forming bleach activator. By Bleach activator is meant herin a compound which reacts with peroxygen bleach like hydrogen peroxide to form a Peracid. The peracid thus formed constitutes the activated bleach. Suitable bleach activators to be used herin include those belonging to the class of esters amides, imides or anhydrides, Suitable examples are tetracetyl athylene diamine (TAED), sodium 3,5,5 trimethyl hexanoyloxybenzene sulphonat, diperoxy dodecanoic acid, 4-(dodecanoyloxy)benzenesulfonate (LOBS), 4-(decanoyloxy)benzenesu lfonate, 4-(decanoyloxy)benzoate (DOBS), 4-(3,5,5-trimethylhexanoyloxyl)benzenesulfonate (ISONOBS), tetraacetylethylenediamine (TAED) and 4-(nonanoyloxy)benzenesulfonate (NOBS), and/or those disclosed in WO98/17767. A particular family of bleach activators of interest was disclosed in EP624154 and particulary preferred in that family is acetyl triethyl citrate (ATC). ATC or a short chain triglyceride like Triacin has the advantage that it is environmental friendly as it eventually degrades into citric acid and alcohol. Furthermore acethyl triethyl citrate and triacetin has a good hydrolytical stability in the product upon storage and it is an efficient bleach activator. Finally ATC provides a good building capacity to the laundry additive. Alternatively, the bleaching system may comprise peroxyacids of, for example, the amide, imide, or sulfone type. The bleaching system may also comprise peracids such as 6-(phthaloylamino)percapronic acid (PAP). The bleaching system may also include a bleach catalyst. In some embodiments the bleach component may be an organic catalyst selected from the group consisting of organic catalysts having the following formulae:

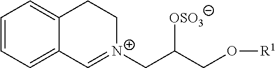

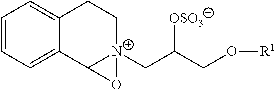

(iii) and mixtures thereof; wherein each R¹ is independently a branched alkyl group containing from 9 to 24 carbons or linear alkyl group containing from 11 to 24 carbons, preferably each R¹ is independently a branched alkyl group containing from 9 to 18 carbons or linear alkyl group containing from 11 to 18 carbons, more preferably each R¹ is independently selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl. Other exemplary bleaching systems are described, e.g., in WO2007/087258, WO2007/087244, WO2007/087259, WO2007/087242. Suitable photobleaches may for example be sulfonated zinc phthalocyanine

### Polymers

The detergent may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs. Exemplary polymers include (carboxymethyl)cellulose (CMC), poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and polycarboxylates such as PAA, PAA/PMA, poly-aspartic acid, lauryl methacrylate/acrylic acid copolymers, methacrylic acid/ethyl acrylate emulsion co/terpolymers, terpolymers of carboxylate/sulfonate/nonionic functional motifs, hydrophobically modified CMC (HM-CMC) and silicones, copolymers of terephthalic acid and oligomeric glycols, copolymers of polyethylene terephthalate and polyoxyethene terephthalate (PET-POET), PVP, poly(vinylimidazole) (PVI), poly(vinylpyridin-N-oxide) (PVPO or PVPNO) and polyvinylpyrrolidone-vinylimidazole (PVPVI). Further exemplary polymers include sulfonated polycarboxylates, sulfonated polystyrenes, co-polymers of sulfonated styrenes and maleic anhydride, polyethylene oxide and polypropylene oxide (PEO-PPO), diquaternium ethoxy sulphate and polyester soil release polymers as disclosed in WO 2011079459. Other exemplary polymers are disclosed in, e.g., WO 2006/130575. Salts of the above-mentioned polymers are also contemplated.

### Fabric Hueing Agents

The detergent compositions of the present invention may also include fabric hueing agents such as dyes or pigments which when formulated in detergent compositions can deposit onto a fabric when said fabric is contacted with a wash liquor comprising said detergent compositions thus altering the tint of said fabric through absorption/reflection of visible light. Fluorescent whitening agents emit at least some visible light. In contrast, fabric hueing agents alter the tint of a surface as they absorb at least a portion of the visible light spectrum. Suitable fabric hueing agents include dyes and dye-clay conjugates, and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, for example as described in WO2005/03274, WO2005/03275, WO2005/03276 and EP1876226 (hereby incorporated by reference). The detergent composition preferably comprises from about 0.00003 wt % to about 0.2 wt %, from about 0.00008 wt % to about 0.05 wt %, or even from about 0.0001 wt % to about 0.04 wt % fabric hueing agent. The composition may comprise from 0.0001 wt % to 0.2 wt % fabric hueing agent, this may be especially preferred when the composition is in the form of a unit dose pouch. Suitable hueing agents are also disclosed in, e.g., WO 2007/087257, WO2007/087243.

### Anti-Foaming Agents

The detergent compositions of the present invention may also include 0-20 wt % foam regulators or anti-foaming agents such as silicon oils or silicon compounds deposited on carrier materials.

### Additional Enzymes

The detergent additive as well as the detergent composition may comprise one or more additional enzymes such as a protease, lipase, cutinase, an amylase, carbohydrase, pectinase, mannanase, arabinase, galactanase, xylanase, oxidase, e.g., a laccase, and/or peroxidase.

In general the properties of the selected enzyme(s) should be compatible with the selected detergent, (i.e., pH-optimum, compatibility with other enzymatic and non-enzymatic ingredients, etc.), and the enzyme(s) should be present in effective amounts.

Proteases:

Suitable proteases include those of animal, vegetable or microbial origin. Microbial origin is preferred. Chemically modified or protein engineered mutants are included. The protease may be a serine protease or a metalloprotease, preferably an alkaline microbial protease or a trypsin-like protease. Examples of alkaline proteases are subtilisins, especially those derived from Bacillus, e.g., subtilisin Novo, subtilisin Carlsberg, subtilisin 309, subtilisin 147 and subtilisin 168 (described in WO 89/06279). Examples of trypsin-like proteases are trypsin (e.g., of porcine or bovine origin) and the Fusarium protease described in WO 89/06270 and WO 94/25583.

Examples of useful proteases are the variants described in WO 92/19729, WO 98/20115, WO 98/20116, and WO 98/34946, especially the variants with substitutions in one or more of the following positions: 27, 36, 57, 76, 87, 97, 101, 104, 120, 123, 167, 170, 194, 206, 218, 222, 224, 235, and 274.

Preferred commercially available protease enzymes include Alcalase™, Savinase™ Primase™, Duralase™, Esperase™, and Kannase™ (Novozymes NS), Maxatase™, Maxacal™ Maxapem™, Properase™, Purafect™, Purafect OxP™, FN2™, and FN3™ (Genencor International Inc.).

Lipases and Cutinases:

Suitable lipases and cutinases include those of bacterial or fungal origin. Chemically modified or protein engineered mutants are included. Examples include lipase from Thermomyces, e.g., from T. lanuginosus (previously named Humicola lanuginosa) as described in EP 258 068 and EP 305 216, cutinase from Humicola, e.g. H. insolens as described in WO 96/13580, a Pseudomonas lipase, e.g., from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g., from B. subtilis (Dartois et al., 1993, Biochemica et Biophysica Acta, 1131: 253-360), B. stearothermophilus (JP 64/744992) or B. pumilus (WO 91/16422).

Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079, WO 97/07202, WO 00/060063, WO2007/087508 and WO 2009/109500.

Preferred commercially available lipase enzymes include Lipolase™, Lipolase Ultra™′ and Lipex™; Lecitase™, Lipolex™; Lipoclean™, Lipoprime™ (Novozymes NS). Other commercially available lipases include Lumafast (Genencor Int Inc); Lipomax (Gist-Brocades/Genencor Int Inc) and Bacillus sp lipase from Solvay.

Amylases:

Suitable amylases (α and/or β) include those of bacterial or fungal origin. Chemically modified or protein engineered mutants are included. Amylases include, for example, α-amylases obtained from Bacillus, e.g., a special strain of Bacillus licheniformis, described in more detail in GB 1,296,839.

Examples of useful amylases are the variants described in WO 94/02597, WO 94/18314, WO 96/23873, and WO 97/43424, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444.

Commercially available amylases are Duramyl™, Termamyl™, Fungamyl™ and BAN™ (Novozymes NS), Rapidase™ and Purastar™ (from Genencor International Inc.).

Peroxidases/Oxidases:

Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257.

Commercially available peroxidases include Guardzyme™ (Novozymes NS).

The detergent enzyme(s) may be included in a detergent composition by adding separate additives containing one or more enzymes, or by adding a combined additive comprising all of these enzymes. A detergent additive of the invention, i.e., a separate additive or a combined additive, can be formulated, for example, as a granulate, liquid, slurry, etc. Preferred detergent additive formulations are granulates, in particular non-dusting granulates, liquids, in particular stabilized liquids, or slurries.

Non-dusting granulates may be produced, e.g., as disclosed in U.S. Pat. Nos. 4,106,991 and 4,661,452 and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP 238,216.

### Adjunct Materials

Any detergent components known in the art for use in laundry detergents may also be utilized. Other optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, foam boosters, foam (suds) regulators, perfumes, soil-suspending agents, softeners, suds suppressors, tarnish inhibitors, and wicking agents, either alone or in combination. Any ingredient known in the art for use in laundry detergents may be utilized. The choice of such ingredients is well within the skill of the artisan.

Dispersants—The detergent compositions of the present invention can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

Dye Transfer Inhibiting Agents—The detergent compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

Soil release polymers—The detergent compositions of the present invention may also include one or more soil release polymers which aid the removal of soils from fabrics such as cotton and polyester based fabrics, in particular the removal of hydrophobic soils from polyester based fabrics. The soil release polymers may for example be nonionic or anionic terephthalte based polymers, polyvinyl caprolactam and related copolymers, vinyl graft copolymers, polyester polyamides see for example Chapter 7 in Powdered Detergents, Surfactant science series volume 71, Marcel Dekker, Inc. Another type of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523 (hereby incorporated by reference). Furthermore random graft co-polymers are suitable soil release polymers Suitable graft co-polymers are described in more detail in WO 2007/138054, WO 2006/108856 and WO 2006/113314 (hereby incorporated by reference). Other soil release polymers are substituted polysaccharide structures especially substituted cellulosic structures such as modified cellulose deriviatives such as those described in EP 1867808 or WO 2003/040279 (both are hereby incorporated by reference). Suitable cellulosic polymers include cellulose, cellulose ethers, cellulose esters, cellulose amides and mixtures thereof. Suitable cellulosic polymers include anionically modified cellulose, nonionically modified cellulose, cationically modified cellulose, zwitterionically modified cellulose, and mixtures thereof. Suitable cellulosic polymers include methyl cellulose, carboxy methyl cellulose, ethyl cellulose, hydroxyl ethyl cellulose, hydroxyl propyl methyl cellulose, ester carboxy methyl cellulose, and mixtures thereof.

Anti-redeposition agents—The detergent compositions of the present invention may also include one or more anti-redeposition agents such as carboxymethylcellulose (CMC), polyvinyl alcohol (PVA), polyvinylpyrrolidone (PVP), polyoxyethylene and/or polyethyleneglycol (PEG), homopolymers of acrylic acid, copolymers of acrylic acid and maleic acid, and ethoxylated polyethyleneimines. The cellulose based polymers described under soil release polymers above may also function as anti-redeposition agents.

Other suitable adjunct materials include, but are not limited to, anti-shrink agents, anti-wrinkling agents, bactericides, binders, carriers, dyes, enzyme stabilizers, fabric softeners, fillers, foam regulators, hydrotropes, perfumes, pigments, sod suppressors, solvents, and structurants for liquid detergents and/or structure elasticizing agents.

### Formulation of Detergent Products

The detergent composition of the invention may be in any convenient form, e.g., a bar, a homogenous tablet, a tablet having two or more layers, a pouch having one or more compartments, a regular or compact powder, a granule, a paste, a gel, or a regular, compact or concentrated liquid.

Detergent formulation forms: Layers (same or different phases), Pouches, versus forms for Machine dosing unit.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxyprpyl methyl cellulose (HPMC). Preferably the level of polymer in the film for example PVA is at least about 60%. Preferred average molecular weight will typically be about 20,000 to about 150,000. Films can also be of blend compositions comprising hydrolytically degradable and water soluble polymer blends such as polyactide and polyvinyl alcohol (known under the Trade reference M8630 as sold by Chris Craft In. Prod. Of Gary, Ind., US) plus plasticisers like glycerol, ethylene glycerol, Propylene glycol, sorbitol and mixtures thereof. The pouches can comprise a solid laundry cleaning composition or part components and/or a liquid cleaning composition or part components separated by the water soluble film. The compartment for liquid components can be different in composition than compartments containing solids. Ref: (US2009/0011970 A1).

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

### Definition/Characteristics of the Forms

A liquid or gel detergent, which is not unit dosed, may be aqueous, typically containing at least 20% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent. A liquid or gel detergent may be non-aqueous.

### Granular Detergent Formulations

A granular detergent may be formulated as described in WO09/092699, EP1705241, EP1382668, WO07/001262, U.S. Pat. No. 6,472,364, WO04/074419 or WO09/102854. Other useful detergent formulations are described in WO09/124162, WO09/124163, WO09/117340, WO09/117341, WO09/117342, WO09/072069, WO09/063355, WO09/132870, WO09/121757, WO09/112296, WO09/112298, WO09/103822, WO09/087033, WO09/050026, WO09/047125, WO09/047126, WO09/047127, WO09/047128, WO09/021784, WO09/010375, WO09/000605, WO09/122125, WO09/095645, WO09/040544, WO09/040545, WO09/024780, WO09/004295, WO09/004294, WO09/121725, WO09/115391, WO09/115392, WO09/074398, WO09/074403, WO09/068501, WO09/065770, WO09/021813, WO09/030632, and WO09/015951, WO2011025615, WO2011016958, WO2011005803, WO2011005623, WO2011005730, WO2011005844, WO2011005904, WO2011005630, WO2011005830, WO2011005912, WO2011005905, WO2011005910, WO2011005813, WO2010135238, WO2010120863, WO2010108002, WO2010111365, WO2010108000, WO2010107635, WO2010090915, WO2010033976, WO2010033746, WO2010033747, WO2010033897, WO2010033979, WO2010030540, WO2010030541, WO2010030539, WO2010024467, WO2010024469, WO2010024470, WO2010025161, WO2010014395, WO2010044905, WO2010145887, WO2010142503, WO2010122051, WO2010102861, WO2010099997, WO2010084039, WO2010076292, WO2010069742, WO2010069718, WO2010069957, WO2010057784, WO2010054986, WO2010018043, WO2010003783, WO2010003792, WO2011023716, WO2010142539, WO2010118959, WO2010115813, WO2010105942, WO2010105961, WO2010105962, WO2010094356, WO2010084203, WO2010078979, WO2010072456, WO2010069905, WO2010076165, WO2010072603, WO2010066486, WO2010066631, WO2010066632, WO2010063689, WO2010060821, WO2010049187, WO2010031607, WO2010000636.

The invention is further summarised in the below paragraphs:

1a. A method for reformulating a detergent composition wherein a first detergent formulation comprising an optical brightener and providing a given Y value is reformulated by reducing the amount of optical brightener by at least 20% and including a cellulase in an amount so that the Y value provided by the reformulated composition is equal to or higher than the Y value provided by the first detergent formulation.

2a. The method according to paragraph 1a, wherein the cellulase exhibits endo-beta-1,4-glucanase activity.

3a. The method according to paragraphs 1a or 2a, wherein the cellulase is obtainable by or -derived from a strain of Bacillus, Humicola, Trichoderma, Myceliophthora, Penicillium, Irpex, Aspergillus, Scytalidium, Thielavia or Fusarium.

4a. The method according to any of the above paragraphs wherein the enzyme is obtainable by or derivable from a strain of Bacillus sp., preferable the strain DSM 12648, Humicola insolens, Fusarium oxysporum, Myceliophthora thermophile, Thielavia terrestris or Trichoderma reesei.

5a. The method according to any of the above paragraphs, wherein the cellulase is selected from the group comprising:

a) an endo-beta-1,4-glucanase enzyme having a sequence of at least 60% identity to the amino acid sequence of position 1 to position 773 of SEQ ID NO:1;

b) the endo-beta-1,4-glucanase enzyme having the amino acid sequence of positions 1 to 773 in SEQ ID NO:1;

c) an endo-beta-1,4-glucanase enzyme having a sequence of at least 60% identity to the amino acid sequence of position 1 to position 284 of SEQ ID NO: 2;

d) the endo-beta-1,4-glucanase enzyme having the amino acid sequence of positions 1 to 284 in SEQ ID NO:2;

e) an endo-beta-1,4-glucanase enzyme having a sequence of at least 60% identity to the amino acid sequence of position 1 to position 415 of SEQ ID NO:3;

f) the endo-beta-1,4-glucanase enzyme having the amino acid sequence of positions 1 to 415 in SEQ ID NO:3;

g) an endo-beta-1,4-glucanase enzyme having a sequence of at least 60% identity to the amino acid sequence of position 1 to position 278 of SEQ ID NO:4;

h) the endo-beta-1,4-glucanase enzyme having the amino acid sequence of positions 1 to 278 in SEQ ID NO:4;

i) a polypeptide endogenous to one of the following Bacillus species selected from the group consisting of: KSM S237, KSM 1139, KSM 64, KSM N131, KSM 635 (FERM BP 1485), KSM 534 (FERM BP 1508), KSM 53 (FERM BP 1509), KSM 577 (FERM BP 1510), KSM 521 (FERM BP 1507), KSM 580 (FERM BP 1511), KSM 588 (FERM BP 1513), KSM 597 (FERM BP 1514), KSM 522 (FERM BP 1512), KSM 3445 (FERM BP 1506), KSM 425 (FERM BP 1505), and mixtures thereof; or
j) an endoglucanase having a sequence of at least 60% identity to the amino acid sequence of SEQ. ID NO:5 or a variant obtained by substituting the amino acid residue of a cellulase having an amino acid sequence exhibiting at least 60 percent, preferably 95 percent, more preferably 98 percent or 99 percent identity with the amino acid sequence represented by SEQ. ID NO:5 at (a) position 10, (b) position 16, (c) position 22, (d) position 33, (e) position 39, (f) position 76, (g) position 109, (h) position 242, (i) position 263, (j) position 308, (k) position 462, (l) position 466, (m) position 468, (n) position 552, (o) position 564, and/or (p) position 608 in SEQ ID NO:5 and/or at a position corresponding thereto with another amino acid residue;

k) an endoglucanase selected from the group consisting of the following endoglucanase variants: Egl-237, Egl-1139, Egl-64, Egl-N131b and mixtures thereof;

l) a cellulase K having the following physical and chemical properties:

(1) Activity: Having a Cx enzymatic activity of acting on carboxymethyl cellulose along with a weak C1 enzymatic activity and a weak beta-glucoxidase activity;

(2) Specificity on Substrates: Acting on carboxymethyl cellulose (CMC), crystalline cellulose, Avicell, cellobiose, and p-nitrophenyl cellobioside (PNPC);

(3) Having a working pH in the range of 4 to 12 and an optimum pH in the range of 9 to 10;

(4) Having stable pH values of 4.5 to 10.5 and 6.8 to 10 when allowed to stand at 40 degrees centigrade for 10 minutes and 30 minutes, respectively;

(5) Working in a wide temperature range of from 10 to 65 degrees centigrade with an optimum temperature being recognized at about 40 degrees C.;

(6) Influences of chelating agents: The activity not impeded with ethylenediamine tetraacetic acid (EDTA), ethyleneglycol-bis-(beta-aminoethylether) N,N,N′,N″-tetraacetic acid (EGTA), N,N-bis(carboxymethyl)glycine (nitrilotriacetic acid) (NTA), sodium tripolyphosphate (STPP) and zeolite;

(7) Influences of surface active agents: Undergoing little inhibition of activity by means of surface active agents such as sodium linear alkylbenzenesulfonates (LAS), sodium alkylsulfates (AS), sodium polyoxyethylene alkylsulfates (ES), sodium alphaolefinsulfonates (AOS), sodium alpha-sulfonated aliphatic acid esters (alpha-SFE), sodium alkylsulfonates (SAS), polyoxyethylene secondary alkyl ethers, fatty acid salts (sodium salts), and dimethyldialkylammonium chloride;

(8) Having a strong resistance to proteinases; and

(9) Molecular weight (determined by gel chromatography): Having a maximum peak at 180,000 plus or minus 10,000;

m) a cellulase K obtained by isolation from a culture product of Bacillus sp KSM-635;

n) an endoglucanase selected from the group consisting of: Cellulase K-534 from KSM 534, FERM BP 1508,

Cellulase K-539 from KSM 539, FERM BP 1509,

Cellulase K-577 from KSM 577, FERM BP 1510,

Cellulase K-521 from KSM 521, FERM BP 1507,

Cellulase K-580 from KSM 580, FERM BP 1511,

Cellulase K-588 from KSM 588, FERM BP 1513,

Cellulase K-597 from KSM 597, FERM BP 1514,

Cellulase K-522 from KSM 522, FERM BP 1512,

Cellulase E-II from KSM 522, FERM BP 1512,

Cellulase E-III from KSM 522, FERM BP 1512,

Cellulase K-344 from KSM 344, FERM BP 1506,

Cellulase K-425 from KSM 425, FERM BP 1505, and mixtures thereof;

o) an endoglucanase selected from the group consisting of endoglucanases derived from Bacillus species KSM-N, preferably the endoglucanase Egl-546H derived from Bacillus sp. KSM-N546;

p) and mixtures thereof.

6a. The method according to any of the above paragraphs, wherein the cellulase is comprised at a level of between 0.1 and 600 ECU/L wash liquid, preferably between 0.3 and 300, even more preferred between 0.5 and 100 or most preferred between 3 and 30 ECU/L wash liquid.

7a. The method according to any of the above paragraphs, wherein the cellulase is comprised at a level of between 0.5 and 100 ECU/g detergent composition, preferably between 1 and 75, or even more preferred between 1.35 and 50 ECU/g detergent composition.

8a. The method according to any of the above paragraphs, wherein the amount of optical brightener is reduced by at least 30%, preferably by at least 40% or more preferred by at least 50%, or by at least 60%, or even more preferred by at least 70%, or most preferred by at least 80% or even by at least 90%.

9a. A detergent composition comprising an optical brightener and a cellulase and from 0.1 percent to 60 percent by weight of surfactant, wherein the optical brightener is comprised at a level of at most 0.75% by weight of the composition, preferably at most 0.5% by weight of the composition, such as at most 0.4, or 0.3, or 0.2, or 0.1, or 0.05%, or at most 0.04%, or 0.03 or 0.02 or 0.01 or 0.005% by weight of the composition.

10a. A detergent composition according to paragraph 9a, wherein the cellulase is comprised in an amount of at least 0.5 ECU/g of the composition.

11a. A detergent composition according to paragraph 9a or 10a, wherein the enzyme exhibits endo-beta-1,4-glucanase activity.

12a. A detergent composition according to paragraphs 9a to 11a, wherein the enzyme is obtainable by or derived from a strain of Bacillus, Humicola, Trichoderma, Myceliophthora, Penicillium, Irpex, Aspergillus, Scytalidium, Thielavia or Fusarium.

13a. A detergent composition according to any of paragraphs 9a-12a, wherein the enzyme is obtainable by or derivable from a strain of Bacillus sp., preferably the strain DSM 12648, Humicola insolens, Fusarium oxysporum, Myceliophthora thermophile, Thielavia terrestris or Trichoderma reesei.

14a. The detergent composition according to any of paragraphs 9a-13a, wherein the cellulase is selected from the group comprising:

a) an endo-beta-1,4-glucanase enzyme having a sequence of at least 60% identity to the amino acid sequence of position 1 to position 773 of SEQ ID NO:1;

b) the endo-beta-1,4-glucanase enzyme having the amino acid sequence of positions 1 to 773 in SEQ ID NO:1;

c) an endo-beta-1,4-glucanase enzyme having a sequence of at least 60% identity to the amino acid sequence of position 1 to position 284 of SEQ ID NO: 2;

d) the endo-beta-1,4-glucanase enzyme having the amino acid sequence of positions 1 to 284 in SEQ ID NO:2;

e) an endo-beta-1,4-glucanase enzyme having a sequence of at least 60% identity to the amino acid sequence of position 1 to position 415 of SEQ ID NO:3;

f) the endo-beta-1,4-glucanase enzyme having the amino acid sequence of positions 1 to 415 in SEQ ID NO:3;

g) an endo-beta-1,4-glucanase enzyme having a sequence of at least 60% identity to the amino acid sequence of position 1 to position 278 of SEQ ID NO:4;

h) the endo-beta-1,4-glucanase enzyme having the amino acid sequence of positions 1 to 278 in SEQ ID NO:4;

i) a polypeptide endogenous to one of the following Bacillus species selected from the group consisting of: KSM S237, KSM 1139, KSM 64, KSM N131, KSM 635 (FERM BP 1485), KSM 534 (FERM BP 1508), KSM 53 (FERM BP 1509), KSM 577 (FERM BP 1510), KSM 521 (FERM BP 1507), KSM 580 (FERM BP 1511), KSM 588 (FERM BP 1513), KSM 597 (FERM BP 1514), KSM 522 (FERM BP 1512), KSM 3445 (FERM BP 1506), KSM 425 (FERM BP 1505), and mixtures thereof; or

j) an endoglucanase having a sequence of at least 60% identity to the amino acid sequence of SEQ. ID NO:5 or a variant obtained by substituting the amino acid residue of a cellulase having an amino acid sequence exhibiting at least 60 percent, preferably 95 percent, more preferably 98 percent or 99 percent identity with the amino acid sequence represented by SEQ. ID NO:5 at (a) position 10, (b) position 16, (c) position 22, (d) position 33, (e) position 39, (f) position 76, (g) position 109, (h) position 242, (i) position 263, (j) position 308, (k) position 462, (l) position 466, (m) position 468, (n) position 552, (o) position 564, and/or (p) position 608 in SEQ ID NO:5 and/or at a position corresponding thereto with another amino acid residue;

k) an endoglucanase selected from the group consisting of the following endoglucanase variants: Egl-237, Egl-1139, Egl-64, Egl-N131b and mixtures thereof;

l) a cellulase K having the following physical and chemical properties:

(1) Activity: Having a Cx enzymatic activity of acting on carboxymethyl cellulose along with a weak C1 enzymatic activity and a weak beta-glucoxidase activity;

(2) Specificity on Substrates: Acting on carboxymethyl cellulose (CMC), crystalline cellulose, Avicell, cellobiose, and p-nitrophenyl cellobioside (PNPC);

(3) Having a working pH in the range of 4 to 12 and an optimum pH in the range of 9 to 10;

(4) Having stable pH values of 4.5 to 10.5 and 6.8 to 10 when allowed to stand at 40 degrees centigrade for 10 minutes and 30 minutes, respectively;

(5) Working in a wide temperature range of from 10 to 65 degrees centigrade with an optimum temperature being recognized at about 40 degrees C.;

(6) Influences of chelating agents: The activity not impeded with ethylenediamine tetraacetic acid (EDTA), ethyleneglycol-bis-(beta-aminoethylether) N,N,N′,N″-tetraacetic acid (EGTA), N,N-bis(carboxymethyl)glycine (nitrilotriacetic acid) (NTA), sodium tripolyphosphate (STPP) and zeolite;

(7) Influences of surface active agents: Undergoing little inhibition of activity by means of surface active agents such as sodium linear alkylbenzenesulfonates (LAS), sodium alkylsulfates (AS), sodium polyoxyethylene alkylsulfates (ES), sodium alphaolefinsulfonates (AOS), sodium alpha-sulfonated aliphatic acid esters (alpha-SFE), sodium alkylsulfonates (SAS), polyoxyethylene secondary alkyl ethers, fatty acid salts (sodium salts), and dimethyldialkylammonium chloride;

(8) Having a strong resistance to proteinases; and

(9) Molecular weight (determined by gel chromatography): Having a maximum peak at 180,000 plus or minus 10,000;

m) a cellulase K obtained by isolation from a culture product of Bacillus sp KSM-635;

n) an endoglucanase selected from the group consisting of:

Cellulase K-534 from KSM 534, FERM BP 1508,

Cellulase K-539 from KSM 539, FERM BP 1509,

Cellulase K-577 from KSM 577, FERM BP 1510,

Cellulase K-521 from KSM 521, FERM BP 1507,

Cellulase K-580 from KSM 580, FERM BP 1511,

Cellulase K-588 from KSM 588, FERM BP 1513,

Cellulase K-597 from KSM 597, FERM BP 1514,

Cellulase K-522 from KSM 522, FERM BP 1512,

Cellulase E-II from KSM 522, FERM BP 1512,

Cellulase E-III from KSM 522, FERM BP 1512,

Cellulase K-344 from KSM 344, FERM BP 1506,

Cellulase K-425 from KSM 425, FERM BP 1505, and mixtures thereof;

o) an endoglucanase selected from the group consisting of endoglucanases derived from Bacillus species KSM-N, preferably the endoglucanase Egl-546H derived from Bacillus sp. KSM-N546;

p) and mixtures thereof.

15a. The detergent composition according to any of paragraphs 9a-14a, wherein the optical brightener is selected from the group comprising benzenesulfonic acid, 2,2′-(1,2-ethenediyl)bis[5-[4-(4-morpholinyl)-6-(phenylamino)-1,3,5-triazin-2-yl]amino]-, disodium salt; 2,2′-([1,1′-biphenyl]-4,4′-diyldi-2,1-ethenediyl)bis-, disodium salt; diaminostilbene-sulphonic acid derivative including sodium salts of: 4,4′-bis-(2-diethanolamino-4-anilino-s-triazin-6-ylamino) stilbene-2,2′-disulphonate; 4,4′-bis-(2,4-dianilino-s-triazin-6-ylamino) stilbene-2.2′-disulphonate; 4,4′-bis-(2-anilino-4(N-methyl-N-2-hydroxy-ethylamino)-s-triazin-6-ylamino) stilbene-2,2′-disulphonate, 4,4′-bis-(4-phenyl-2,1,3-triazol-2-yl)stilbene-2,2′-disulphonate; 4,4′-bis-(2-anilino-4(1-methyl-2-hydroxy-ethylamino)-s-triazin-6-ylamino) stilbene-2,2′-disulphonate and/or 2-(stilbyl-4″-naptho-1.,2′:4,5)-1,2,3-trizole-2″-sulphonate; or 4,4′-bis-((2-morpholino-4 anilino-s-triazin-6-yl)amino) stilbene disulphonate or 2,2′-bis-(phenyl-styryl) disulphonate, 4.4′-bis-(sulfostyryl)-biphenyl disodium salt, or 4′-bis[(4-anilino-6-morpholino-1,3,5-triazin-2-yl)amino]-stilbene-2,2′-disulfonate or mixtures hereof.

16a. The detergent composition according to paragraph 15a, wherein the optical brightener is selected from the group comprising 4,4′-bis-((2-morpholino-4 anilino-s-triazin-6-yl)amino) stilbene disulphonate, 2,2′-bis-(phenyl-styryl) disulphonate, 4.4′-bis-(sulfostyryl)-biphenyl disodium salt and 4,4′-bis[(4-anilino-6-morpholino-1,3,5-triazin-2-yl)amino]-stilbene-2,2′-disulfonate.

17a. A method of washing a fabric comprising a step of contacting said fabric with the composition of any of paragraphs 9a-16a, then optionally washing and/or rinsing said surface or fabric.

18a. Use of a cellulase as described in paragraph 14a for reducing the amount of optical brighteners in detergent compositions.

19a Use of a cellulase for reducing the amount of optical brighteners by at least 20% from a starting detergent composition without reducing the Y value of a washed textile, wherein the cellulase enzyme is added until an equivalent or better Y value is obtained compared to the starting composition.

And the invention is further summarized in these paragraphs:
1. A detergent composition comprising:
   a. an optical brightener, at a level of at most 0.75% by weight of the composition,
   b. a cellulase and
   c. from 0.1 percent to 60 percent by weight of surfactant
2. A detergent composition according to paragraph 2, wherein the optical brightener is present at most 0.5% by weight of the composition, at most 0.4% by weight of the composition, at the most 0.3% by weight of the composition, at the most 0.26% by weight of the composition, at the most 0.2% by weight of the composition, at the most 0.15% by weight of the composition, at the most 0.1% by weight of the composition, at the most 0.08% by weight of the composition, at the most 0.065% by weight of the composition, at the most 0.05% by weight of the composition, at most 0.04% by weight of the composition, at the most 0.03% by weight of the composition, at the most 0.02% by weight of the composition, at the most 0.01% by weight of the composition or at the most 0.005% by weight of the composition.
3. A detergent composition according to any of paragraphs 1-2, wherein the cellulase is comprised in an amount of 0.1-100 ECU/g detergent composition, 0.2-50 ECU/g detergent composition, 0.3-20 ECU/g detergent composition, 1-10 ECU/g detergent composition or 1.35-9 ECU/g detergent composition.
4. A detergent composition according to any of paragraphs 1-2, wherein the cellulase is comprised in an amount of 1-200 ECU/g detergent composition, 2-100 ECU/g detergent composition, 3-50 ECU/g detergent composition, 5-30 ECU/g detergent composition or 7.5-30 ECU/g detergent composition.
5. A detergent composition according to any of paragraphs 1-4, wherein the enzyme exhibits endo-beta-1,4-glucanase activity.
6. A detergent composition according to any of paragraphs 1-5, wherein the enzyme is obtainable by or derived from a strain of Bacillus, Humicola, Trichoderma, Myceliophthora, Penicillium, Irpex, Aspergillus, Scytalidium, Thielavia or Fusarium.
7. A detergent composition according to any of paragraphs 1-6, wherein the enzyme is obtainable by or derivable from a strain of Bacillus sp., preferably the strain DSM 12648, Humicola insolens, Fusarium oxysporum, Myceliophthora thermophile, Thielavia terrestris or Trichoderma reesei.
8. The detergent composition according to any of paragraphs 1-7, wherein the cellulase is selected from the group comprising:
   a. an endo-beta-1,4-glucanase enzyme having a sequence of at least 60% identity to the amino acid sequence of position 1 to position 773 of SEQ ID NO:1;
   b. the endo-beta-1,4-glucanase enzyme having the amino acid sequence of positions 1 to 773 in SEQ ID NO:1;
   c. an endo-beta-1,4-glucanase enzyme having a sequence of at least 60% identity to the amino acid sequence of position 1 to position 284 of SEQ ID NO: 2;
   d. the endo-beta-1,4-glucanase enzyme having the amino acid sequence of positions 1 to 284 in SEQ ID NO:2;
   e. an endo-beta-1,4-glucanase enzyme having a sequence of at least 60% identity to the amino acid sequence of position 1 to position 415 of SEQ ID NO:3;
   f. the endo-beta-1,4-glucanase enzyme having the amino acid sequence of positions 1 to 415 in SEQ ID NO:3;
   g. an endo-beta-1,4-glucanase enzyme having a sequence of at least 60% identity to the amino acid sequence of position 1 to position 278 of SEQ ID NO:4;
   h. the endo-beta-1,4-glucanase enzyme having the amino acid sequence of positions 1 to 278 in SEQ ID NO:4;
   i. a polypeptide endogenous to one of the following Bacillus species selected from the group consisting of: KSM S237, KSM 1139, KSM 64, KSM N131, KSM 635 (FERM BP 1485), KSM 534 (FERM BP 1508), KSM 53 (FERM BP 1509), KSM 577 (FERM BP 1510), KSM 521 (FERM BP 1507), KSM 580 (FERM BP 1511), KSM 588 (FERM BP 1513), KSM 597 (FERM BP 1514), KSM 522 (FERM BP 1512), KSM 3445 (FERM BP 1506), KSM 425 (FERM BP 1505), and mixtures thereof;
   j. an endoglucanase having a sequence of at least 60% identity to the amino acid sequence of SEQ. ID NO:5 or a variant obtained by substituting the amino acid residue of a cellulase having an amino acid sequence exhibiting at least 60 percent, preferably 95 percent, more preferably 98 percent or 99 percent identity with the amino acid sequence represented by SEQ. ID NO:5 at (a) position 10, (b) position 16, (c) position 22, (d) position 33, (e) position 39, (f) position 76, (g) position 109, (h) position 242, (i) position 263, (j) position 308, (k) position 462, (l) position 466, (m) position 468, (n) position 552, (o) position 564, and/or (p) position 608 in SEQ ID NO:5 and/or at a position corresponding thereto with another amino acid residue;
   k. an endoglucanase selected from the group consisting of the following endoglucanase variants: Egl-237, Egl-1139, Egl-64, Egl-N131b and mixtures thereof;
   l. a cellulase K having the following physical and chemical properties:
      i. Activity: Having a Cx enzymatic activity of acting on carboxymethyl cellulose along with a weak C1 enzymatic activity and a weak beta-glucoxidase activity;
      ii. Specificity on Substrates: Acting on carboxymethyl cellulose (CMC), crystalline cellulose, Avicell, cellobiose, and p-nitrophenyl cellobioside (PNPC);
      iii. Having a working pH in the range of 4 to 12 and an optimum pH in the range of 9 to 10;
      iv. Having stable pH values of 4.5 to 10.5 and 6.8 to 10 when allowed to stand at 40 degrees centigrade for 10 minutes and 30 minutes, respectively;
      v. Working in a wide temperature range of from 10 to 65 degrees centigrade with an optimum temperature being recognized at about 40 degrees C.;
      vi. Influences of chelating agents: The activity not impeded with ethylenediamine tetraacetic acid (EDTA), ethyleneglycol-bis-(beta-aminoethylether) N,N,N′,N″-tetraacetic acid (EGTA), N,N-bis(carboxymethyl)glycine (nitrilotriacetic acid) (NTA), sodium tripolyphosphate (STPP) and zeolite;
      vii. Influences of surface active agents: Undergoing little inhibition of activity by means of surface active agents such as sodium linear alkylbenzenesulfonates (LAS), sodium alkylsulfates (AS), sodium polyoxyethylene alkylsulfates (ES), sodium alphaolefinsulfonates (AOS), sodium alpha-sulfonated aliphatic acid esters (alpha-SFE), sodium alkylsulfonates (SAS), polyoxyethylene secondary alkyl ethers, fatty acid salts (sodium salts), and dimethyldialkylammonium chloride;
      viii. Having a strong resistance to proteinases; and
      ix. Molecular weight (determined by gel chromatography): Having a maximum peak at 180,000 plus or minus 10,000;
   m. a cellulase K obtained by isolation from a culture product of Bacillus sp KSM-635;
   n. an endoglucanase selected from the group consisting of:
      Cellulase K-534 from KSM 534, FERM BP 1508,
      Cellulase K-539 from KSM 539, FERM BP 1509,
      Cellulase K-577 from KSM 577, FERM BP 1510,
      Cellulase K-521 from KSM 521, FERM BP 1507,
      Cellulase K-580 from KSM 580, FERM BP 1511,
      Cellulase K-588 from KSM 588, FERM BP 1513,
      Cellulase K-597 from KSM 597, FERM BP 1514,
      Cellulase K-522 from KSM 522, FERM BP 1512,
      Cellulase E-II from KSM 522, FERM BP 1512,
      Cellulase E-III from KSM 522, FERM BP 1512,
      Cellulase K-344 from KSM 344, FERM BP 1506,
      Cellulase K-425 from KSM 425, FERM BP 1505,
      and mixtures thereof;
   o. an endoglucanase selected from the group consisting of endoglucanases derived from Bacillus species KSM-N, preferably the endoglucanase Egl-546H derived from Bacillus sp. KSM-N546;
   p. and mixtures thereof.
9. The detergent composition according to any of paragraphs 1-8, wherein the optical brightener is selected from the group comprising benzenesulfonic acid, 2,2′-(1,2-ethenediyl)bis[5-[4-(4-morpholinyl)-6-(phenylamino)-1,3,5-triazin-2-yl]amino]-, disodium salt; 2,2′-([1,1′-biphenyl]-4,4′-diyldi-2,1-ethenediyl)bis-, disodium salt; diaminostilbene-sulphonic acid derivative including sodium salts of: 4,4′-bis-(2-diethanolamino-4-anilino-s-triazin-6-ylamino) stilbene-2,2′-disulphonate; 4,4′-bis-(2,4-dianilino-s-triazin-6-ylamino) stilbene-2.2′-disulphonate; 4,4′-bis-(2-anilino-4(N-methyl-N-2-hydroxy-ethylamino)-s-triazin-6-ylamino) stilbene-2,2′-disulphonate, 4,4′-bis-(4-phenyl-2,1,3-triazol-2-yl)stilbene-2,2′-disulphonate; 4,4′-bis-(2-anilino-4(1-methyl-2-hydroxy-ethylamino)-s-triazin-6-ylamino) stilbene-2,2′-disulphonate and/or 2-(stilbyl-4″-naptho-1.,2′:4,5)-1,2,3-trizole-2″-sulphonate; or 4,4′-bis-((2-morpholino-4 anilino-s-triazin-6-yl)amino) stilbene disulphonate or 2,2′-bis-(phenyl-styryl) disulphonate, 4.4′-bis-(sulfostyryl)-biphenyl disodium salt, or 4′-bis[(4-anilino-6-morpholino-1,3,5-triazin-2-yl)amino]-stilbene-2,2′-disulfonate or mixtures hereof.
10. The detergent composition according to any of paragraphs 1-9, wherein the optical brightener is selected from the group comprising 4,4′-bis-((2-morpholino-4 anilino-s-triazin-6-yl)amino) stilbene disulphonate, 2,2′-bis-(phenyl-styryl) disulphonate, 4.4′-bis-(sulfostyryl)-biphenyl disodium salt and 4,4′-bis[(4-anilino-6-morpholino-1,3,5-triazin-2-yl)amino]-stilbene-2,2′-disulfonate.
11. The detergent composition according to any of paragraphs 1-10, wherein the optical brightener is 4.4′-bis-(sulfostyryl)-biphenyl disodium salt.
12. The detergent composition according to any of paragraphs 1-11, wherein the detergent composition comprises 0.26 wt % 4.4′-bis-(sulfostyryl)-biphenyl disodium salt, 4.5 ECU/g of a cellulase having SEQ ID NO 1 and 18.7 wt % of a surfactant.
13. The detergent composition according to any of paragraphs 1-11, wherein the detergent composition comprises 0.025 wt % 4.4′-bis-(sulfostyryl)-biphenyl disodium salt, 15 ECU/g of a cellulase having SEQ ID NO 3 and 12 wt % of a surfactant.
14. Use of a cellulase for reducing the amount of optical brightener in a detergent composition comprising an optical brightener.
15. Use according to paragraph 14, wherein the amount of optical brightener is reduced by at least 20%.
16. Use according to any of paragraphs 14 or 15, wherein the amount of optical brightener is reduced by at least 30%, by at least 40%, by at least 50%, by at least 60%, by at least 70%, by at least 75%, by at least 80% or by at least 90%.
17. Use according to any of paragraphs 14-16, wherein, wherein the cellulase is obtainable by or derived from a strain of Bacillus, Humicola, Trichoderma, Myceliophthora, Penicilfium, Irpex, Aspergillus, Scytalidium, Thielavia or Fusarium.
18. Use according to any of paragraphs 14-17, wherein the cellulase is obtainable by or -derivable from a strain of Bacillus sp., preferable the strain DSM 12648, Humicola insolens, Fusarium oxysporum, Myceliophthora thermophile, Thielavia terrestris or Trichoderma reesei.
19. Use according to any of paragraphs 14-18, wherein the cellulase is selected from the group consisting of:
   a. an endo-beta-1,4-glucanase enzyme having a sequence of at least 60% identity to the amino acid sequence of position 1 to position 773 of SEQ ID NO:1;
   b. the endo-beta-1,4-glucanase enzyme having the amino acid sequence of positions 1 to 773 in SEQ ID NO:1;
   c. an endo-beta-1,4-glucanase enzyme having a sequence of at least 60% identity to the amino acid sequence of position 1 to position 284 of SEQ ID NO: 2;
   d. the endo-beta-1,4-glucanase enzyme having the amino acid sequence of positions 1 to 284 in SEQ ID NO:2;
   e. an endo-beta-1,4-glucanase enzyme having a sequence of at least 60% identity to the amino acid sequence of position 1 to position 415 of SEQ ID NO:3;
   f. the endo-beta-1,4-glucanase enzyme having the amino acid sequence of positions 1 to 415 in SEQ ID NO:3;
   g. an endo-beta-1,4-glucanase enzyme having a sequence of at least 60% identity to the amino acid sequence of position 1 to position 278 of SEQ ID NO:4;
   h. the endo-beta-1,4-glucanase enzyme having the amino acid sequence of positions 1 to 278 in SEQ ID NO:4;
   i. a polypeptide endogenous to one of the following Bacillus species selected from the group consisting of: KSM S237, KSM 1139, KSM 64, KSM N131, KSM 635 (FERM BP 1485), KSM 534 (FERM BP 1508), KSM 53 (FERM BP 1509), KSM 577 (FERM BP 1510), KSM 521 (FERM BP 1507), KSM 580 (FERM BP 1511), KSM 588 (FERM BP 1513), KSM 597 (FERM BP 1514), KSM 522 (FERM BP 1512), KSM 3445 (FERM BP 1506), KSM 425 (FERM BP 1505), and mixtures thereof;
   j. an endoglucanase having a sequence of at least 60% identity to the amino acid sequence of SEQ. ID NO:5 or a variant obtained by substituting the amino acid residue of a cellulase having an amino acid sequence exhibiting at least 60 percent, preferably 95 percent, more preferably 98 percent or 99 percent identity with the amino acid sequence represented by SEQ. ID NO:5 at (a) position 10, (b) position 16, (c) position 22, (d) position 33, (e) position 39, (f) position 76, (g) position 109, (h) position 242, (i) position 263, (j) position 308, (k) position 462, (l) position 466, (m) position 468, (n) position 552, (o) position 564, and/or (p) position 608 in SEQ ID NO:5 and/or at a position corresponding thereto with another amino acid residue;
   k. an endoglucanase selected from the group consisting of the following endoglucanase variants: Egl-237, Egl-1139, Egl-64, Egl-N131b and mixtures thereof;
   l. a cellulase K having the following physical and chemical properties:
      i. Activity: Having a Cx enzymatic activity of acting on carboxymethyl cellulose along with a weak C1 enzymatic activity and a weak beta-glucoxidase activity;
      ii. Specificity on Substrates: Acting on carboxymethyl cellulose (CMC), crystalline cellulose, Avicell, cellobiose, and p-nitrophenyl cellobioside (PNPC);
      iii. Having a working pH in the range of 4 to 12 and an optimum pH in the range of 9 to 10;
      iv. Having stable pH values of 4.5 to 10.5 and 6.8 to 10 when allowed to stand at 40 degrees centigrade for 10 minutes and 30 minutes, respectively;
      v. Working in a wide temperature range of from 10 to 65 degrees centigrade with an optimum temperature being recognized at about 40 degrees C.;
      vi. Influences of chelating agents: The activity not impeded with ethylenediamine tetraacetic acid (EDTA), ethyleneglycol-bis-(beta-aminoethylether) N,N,N′,N″-tetraacetic acid (EGTA), N,N-bis(carboxymethyl)glycine (nitrilotriacetic acid) (NTA), sodium tripolyphosphate (STPP) and zeolite;
      vii. Influences of surface active agents: Undergoing little inhibition of activity by means of surface active agents such as sodium linear alkylbenzenesulfonates (LAS), sodium alkylsulfates (AS), sodium polyoxyethylene alkylsulfates (ES), sodium alphaolefinsulfonates (AOS), sodium alpha-sulfonated aliphatic acid esters (alpha-SFE), sodium alkylsulfonates (SAS), polyoxyethylene secondary alkyl ethers, fatty acid salts (sodium salts), and dimethyldialkylammonium chloride;
      viii. Having a strong resistance to proteinases; and
      ix. Molecular weight (determined by gel chromatography): Having a maximum peak at 180,000 plus or minus 10,000;
   m. a cellulase K obtained by isolation from a culture product of Bacillus sp KSM-635;
   n. an endoglucanase selected from the group consisting of:
      Cellulase K-534 from KSM 534, FERM BP 1508,
      Cellulase K-539 from KSM 539, FERM BP 1509,
      Cellulase K-577 from KSM 577, FERM BP 1510,
      Cellulase K-521 from KSM 521, FERM BP 1507,
      Cellulase K-580 from KSM 580, FERM BP 1511,
      Cellulase K-588 from KSM 588, FERM BP 1513,
      Cellulase K-597 from KSM 597, FERM BP 1514,
      Cellulase K-522 from KSM 522, FERM BP 1512,
      Cellulase E-II from KSM 522, FERM BP 1512,
      Cellulase E-III from KSM 522, FERM BP 1512,
      Cellulase K-344 from KSM 344, FERM BP 1506,
      Cellulase K-425 from KSM 425, FERM BP 1505,
      and mixtures thereof;
   o. an endoglucanase selected from the group consisting of endoglucanases derived from Bacillus species KSM-N, preferably the endoglucanase Egl-546H derived from Bacillus sp. KSM-N546;
   p. and mixtures thereof.
20. Use according to any of paragraphs 14-19, wherein the cellulase is used in an amount of 0.1-100 ECU/g detergent composition, 0.2-50 ECU/g detergent composition, 0.3-20 ECU/g detergent composition, 1-10 ECU/g detergent composition or 1.35-9 ECU/g detergent composition.
21. Use according to any of paragraphs 14-19, wherein the cellulase is used in an amount of 1-200 ECU/g detergent composition, 2-100 ECU/g detergent composition, 3-50 ECU/g detergent composition, 5-30 ECU/g detergent composition or 7.5-30 ECU/g detergent composition.
22. Use according to any of paragraphs 14-21, wherein the cellulase is selected from the group consisting of:
   a. an endo-beta-1,4-glucanase enzyme having a sequence of at least 60% identity to the amino acid sequence of position 1 to position 773 of SEQ ID NO:1; and
   b. the endo-beta-1,4-glucanase enzyme having the amino acid sequence of positions 1 to 773 in SEQ ID NO:1;
23. Use according to any of paragraphs 14-21, wherein the cellulase is selected from the group consisting of:
   a. an endo-beta-1,4-glucanase enzyme having a sequence of at least 60% identity to the amino acid sequence of position 1 to position 415 of SEQ ID NO:3; and
   b. the endo-beta-1,4-glucanase enzyme having the amino acid sequence of positions 1 to 415 in SEQ ID NO:3;
24. Use according to any of paragraphs 14-23, wherein the optical brightener is selected from the group comprising benzenesulfonic acid, 2,2′-(1,2-ethenediyl)bis[5-[4-(4-morpholinyl)-6-(phenylamino)-1,3,5-triazin-2-yl]amino]-, disodium salt; 2,2′-([1,1′-biphenyl]-4,4′-diyldi-2,1-ethenediyl)bis-, disodium salt; diaminostilbene-sulphonic acid derivative including sodium salts of: 4,4′-bis-(2-diethanolamino-4-anilino-s-triazin-6-ylamino) stilbene-2,2′-disulphonate; 4,4′-bis-(2,4-dianilino-s-triazin-6-ylamino) stilbene-2.2′-disulphonate; 4,4′-bis-(2-anilino-4(N-methyl-N-2-hydroxy-ethylamino)-s-triazin-6-ylamino) stilbene-2,2′-disulphonate, 4,4′-bis-(4-phenyl-2,1,3-triazol-2-yl)stilbene-2,2′-disulphonate; 4,4′-bis-(2-anilino-4(1-methyl-2-hydroxy-ethylamino)-s-triazin-6-ylamino) stilbene-2,2′-disulphonate and/or 2-(stilbyl-4″-naptho-1.,2′:4,5)-1,2,3-trizole-2″-sulphonate; or 4,4′-bis-(2-morpholino-4 anilino-s-triazin-6-ylamino) stilbene disulphonate or 2,2′-bis-(phenyl-styryl) disulphonate, or 4.4′-bis-(sulfostyryl)-biphenyl disodium salt or mixtures hereof.
25. Use according to any of paragraphs 14-24, wherein the optical brightener is 4.4′-bis-(sulfostyryl)-biphenyl disodium salt.
26. Use according to any of paragraphs 14-25, wherein the whiteness of the textile is maintained.
27. Use according to any of paragraphs 14-25, wherein the whiteness of the textile is improved.
28. Use according to any of paragraphs 14-25 and 27, wherein ΔY value is at least 0.3.
29. Use according to any of paragraphs 14-25 and 27-28, wherein the ΔY value is at least 0.5 at least 0.8, at least 1, at least 1.5 or at least 2.
30. Use according to any of paragraphs 14-29, wherein the detergent composition further comprises an enzyme selected from the group of protease, lipase, cutinase, amylase, carbohydrase, pectinase, mannanase, arabinase, galactanase, xylanase and oxidase.
31. Use according to any of paragraphs 14-30, wherein the protease is Savinase and the amylase is Stainzyme.
32. Use according to any of paragraphs 14-31, wherein the detergent composition is a liquid detergent composition.
33. Use according to any of paragraphs 14-31, wherein the detergent composition is a powder composition.
34. Use according to any of paragraphs 14-33, wherein the detergent composition comprises components selected from the group consisting of surfactants, builders, co-builders, polymers, hydrotropes, anti-foaming agents and fabric hueing agents
35. Method for maintaining or improving the whiteness of a textile, wherein the textile is exposed to a wash liquid comprising a detergent with an optical brightener and a cellulase.
36. Method according to paragraph 35, wherein the cellulase is obtainable by or derived from a strain of Bacillus, Humicola, Trichoderma, Myceliophthora, Penicillium, Irpex, Aspergillus, Scytalidium, Thielavia or Fusarium.
37. Method according to any of paragraph 35-36, wherein the cellulase is obtainable by or -derivable from a strain of Bacillus sp., preferable the strain DSM 12648, Humicola insolens, Fusarium oxysporum, Myceliophthora thermophile, Thielavia terrestris or Trichoderma reesei.
38. Method according to any of paragraphs 35-37, wherein the cellulase is selected from the group consisting of:
   a. an endo-beta-1,4-glucanase enzyme having a sequence of at least 60% identity to the amino acid sequence of position 1 to position 773 of SEQ ID NO:1;
   b. the endo-beta-1,4-glucanase enzyme having the amino acid sequence of positions 1 to 773 in SEQ ID NO:1;
   c. an endo-beta-1,4-glucanase enzyme having a sequence of at least 60% identity to the amino acid sequence of position 1 to position 284 of SEQ ID NO: 2;
   d. the endo-beta-1,4-glucanase enzyme having the amino acid sequence of positions 1 to 284 in SEQ ID NO:2;
   e. an endo-beta-1,4-glucanase enzyme having a sequence of at least 60% identity to the amino acid sequence of position 1 to position 415 of SEQ ID NO:3;
   f. the endo-beta-1,4-glucanase enzyme having the amino acid sequence of positions 1 to 415 in SEQ ID NO:3;
   g. an endo-beta-1,4-glucanase enzyme having a sequence of at least 60% identity to the amino acid sequence of position 1 to position 278 of SEQ ID NO:4;
   h. the endo-beta-1,4-glucanase enzyme having the amino acid sequence of positions 1 to 278 in SEQ ID NO:4;
   i. a polypeptide endogenous to one of the following Bacillus species selected from the group consisting of: KSM S237, KSM 1139, KSM 64, KSM N131, KSM 635 (FERM BP 1485), KSM 534 (FERM BP 1508), KSM 53 (FERM BP 1509), KSM 577 (FERM BP 1510), KSM 521 (FERM BP 1507), KSM 580 (FERM BP 1511), KSM 588 (FERM BP 1513), KSM 597 (FERM BP 1514), KSM 522 (FERM BP 1512), KSM 3445 (FERM BP 1506), KSM 425 (FERM BP 1505), and mixtures thereof;
   j. an endoglucanase having a sequence of at least 60% identity to the amino acid sequence of SEQ. ID NO:5 or a variant obtained by substituting the amino acid residue of a cellulase having an amino acid sequence exhibiting at least 60 percent, preferably 95 percent, more preferably 98 percent or 99 percent identity with the amino acid sequence represented by SEQ. ID NO:5 at (a) position 10, (b) position 16, (c) position 22, (d) position 33, (e) position 39, (f) position 76, (g) position 109, (h) position 242, (i) position 263, (j) position 308, (k) position 462, (l) position 466, (m) position 468, (n) position 552, (o) position 564, and/or (p) position 608 in SEQ ID NO:5 and/or at a position corresponding thereto with another amino acid residue;
   k. an endoglucanase selected from the group consisting of the following endoglucanase variants: Egl-237, Egl-1139, Egl-64, Egl-N131b and mixtures thereof;
   l. a cellulase K having the following physical and chemical properties:
      i. Activity: Having a Cx enzymatic activity of acting on carboxymethyl cellulose along with a weak C1 enzymatic activity and a weak beta-glucoxidase activity;
      ii. Specificity on Substrates: Acting on carboxymethyl cellulose (CMC), crystalline cellulose, Avicell, cellobiose, and p-nitrophenyl cellobioside (PNPC);
      iii. Having a working pH in the range of 4 to 12 and an optimum pH in the range of 9 to 10;
      iv. Having stable pH values of 4.5 to 10.5 and 6.8 to 10 when allowed to stand at 40 degrees centigrade for 10 minutes and 30 minutes, respectively;
      v. Working in a wide temperature range of from 10 to 65 degrees centigrade with an optimum temperature being recognized at about 40 degrees C.;
      vi. Influences of chelating agents: The activity not impeded with ethylenediamine tetraacetic acid (EDTA), ethyleneglycol-bis-(beta-aminoethylether) N,N,N′,N″-tetraacetic acid (EGTA), N,N-bis(carboxymethyl)glycine (nitrilotriacetic acid) (NTA), sodium tripolyphosphate (STPP) and zeolite;
      vii. Influences of surface active agents: Undergoing little inhibition of activity by means of surface active agents such as sodium linear alkylbenzenesulfonates (LAS), sodium alkylsulfates (AS), sodium polyoxyethylene alkylsulfates (ES), sodium alphaolefinsulfonates (AOS), sodium alpha-sulfonated aliphatic acid esters (alpha-SFE), sodium alkylsulfonates (SAS), polyoxyethylene secondary alkyl ethers, fatty acid salts (sodium salts), and dimethyldialkylammonium chloride;
      viii. Having a strong resistance to proteinases; and
      ix. Molecular weight (determined by gel chromatography): Having a maximum peak at 180,000 plus or minus 10,000;
   m. a cellulase K obtained by isolation from a culture product of Bacillus sp KSM-635;
   n. an endoglucanase selected from the group consisting of:
      Cellulase K-534 from KSM 534, FERM BP 1508,
      Cellulase K-539 from KSM 539, FERM BP 1509,
      Cellulase K-577 from KSM 577, FERM BP 1510,
      Cellulase K-521 from KSM 521, FERM BP 1507,
      Cellulase K-580 from KSM 580, FERM BP 1511,
      Cellulase K-588 from KSM 588, FERM BP 1513,
      Cellulase K-597 from KSM 597, FERM BP 1514,
      Cellulase K-522 from KSM 522, FERM BP 1512,
      Cellulase E-II from KSM 522, FERM BP 1512,
      Cellulase E-III from KSM 522, FERM BP 1512,
      Cellulase K-344 from KSM 344, FERM BP 1506,
      Cellulase K-425 from KSM 425, FERM BP 1505,
      and mixtures thereof;
   o. an endoglucanase selected from the group consisting of endoglucanases derived from Bacillus species KSM-N, preferably the endoglucanase Egl-546H derived from Bacillus sp. KSM-N546;
   p. and mixtures thereof.
39. Method according to any of paragraphs 35-38, wherein the amount of cellulase used is in the range of 0.1-100 ECU/g detergent composition, 0.2-50 ECU/g detergent composition, 0.3-20 ECU/g detergent composition, 1-10 ECU/g detergent composition or 1.35-9 ECU/g detergent composition
40. Method according to any of paragraphs 35-39, wherein the amount of cellulase used is in the range of 1-200 ECU/g detergent composition, 2-100 ECU/g detergent composition, 3-50 ECU/g detergent composition, 5-30 ECU/g detergent composition or 7.5-30 ECU/g detergent composition.
41. Method according to any of paragraphs 35-40, wherein the cellulase is selected from the group consisting of:
   a. an endo-beta-1,4-glucanase enzyme having a sequence of at least 60% identity to the amino acid sequence of position 1 to position 773 of SEQ ID NO:1; and
   b. the endo-beta-1,4-glucanase enzyme having the amino acid sequence of positions 1 to 773 in SEQ ID NO:1.
42. Method according to any of paragraphs 35-40, wherein the cellulase is selected from the group consisting of:
   a. an endo-beta-1,4-glucanase enzyme having a sequence of at least 60% identity to the amino acid sequence of position 1 to position 415 of SEQ ID NO:3; and
   b. the endo-beta-1,4-glucanase enzyme having the amino acid sequence of positions 1 to 415 in SEQ ID NO:3;
43. Method according to any of paragraphs 35-42, wherein the optical brightener is selected from the group comprising benzenesulfonic acid, 2,2′-(1,2-ethenediyl)bis[5-[4-(4-morpholinyl)-6-(phenylamino)-1,3,5-triazin-2-yl]amino]-, disodium salt; 2,2′-([1,1′-biphenyl]-4,4′-diyldi-2,1-ethenediyl)bis-, disodium salt; diaminostilbene-sulphonic acid derivative including sodium salts of: 4,4′-bis-(2-diethanolamino-4-anilino-s-triazin-6-ylamino) stilbene-2,2′-disulphonate; 4,4′-bis-(2,4-dianilino-s-triazin-6-ylamino) stilbene-2.2′-disulphonate; 4,4′-bis-(2-anilino-4(N-methyl-N-2-hydroxy-ethylamino)-s-triazin-6-ylamino) stilbene-2,2′-disulphonate, 4,4′-bis-(4-phenyl-2,1,3-triazol-2-yl)stilbene-2,2′-disulphonate; 4,4′-bis-(2-anilino-4(1-methyl-2-hydroxy-ethylamino)-s-triazin-6-ylamino) stilbene-2,2′-disulphonate and/or 2-(stilbyl-4″-naptho-1.,2′:4,5)-1,2,3-trizole-2″-sulphonate; or 4,4′-bis-(2-morpholino-4 anilino-s-triazin-6-ylamino) stilbene disulphonate or 2,2′-bis-(phenyl-styryl) disulphonate, or 4.4′-bis-(sulfostyryl)-biphenyl disodium salt or mixtures hereof.
44. Method according to any of paragraphs 35-43, wherein the optical brightener is 4.4′-bis-(sulfostyryl)-biphenyl disodium salt.
45. Method according to any of paragraphs 35-44, wherein the detergent composition further comprises an enzyme selected from the group consisting of protease, lipase, cutinase, amylase, carbohydrase, pectinase, mannanase, arabinase, galactanase, xylanase and oxidase.
46. Method according to any of paragraphs 35-45, wherein the protease is Savinase and the amylase is Stainzyme.
47. Method according to any of paragraphs 35-46, wherein the detergent composition is a liquid detergent composition.
48. Method according to any of paragraphs 35-46, wherein the detergent composition is a powder composition.
49. Method according to any of paragraphs 35-48, wherein the detergent composition comprises components selected from the group consisting of surfactants, builders, co-builders, polymers, hydrotropes, anti-foaming agents and fabric hueing agents.
50. Method according to any of paragraphs 35-49, wherein the textile is exposed to a wash liquid more than one time.
51. Method according to any of paragraphs 35-50, wherein the textile is exposed to a wash liquid several times, such as more than two times, more than three times, more than four times, more than five times, more than six times, more than seven times, more than eight times, more than nine times, more than ten times, more than fifteen times or more than twenty times.
52. Method according to any of paragraphs 35-51, wherein the textile is selected from the group consisting of: cellulose based textiles and textiles which partly is made of cellulose based textile.
53. Method according to any of paragraphs 35-52, wherein the textile is cotton or a cotton blend.
54. Method according to any of paragraphs 35-53, wherein the whiteness of the textile is maintained.
55. Method according to any of paragraphs 35-53, wherein the whiteness of the textile is improved.
56. Method according to any of paragraphs 35-53 and 55, wherein ΔY value is at least 0.3.
57. Method according to any of paragraphs 35-53 and 55-56, wherein the ΔY is at least 0.5 at least 0.8, at least 1, at least 1.5 or at least 2.
58. A method for reformulating a detergent composition wherein a first detergent formulation comprising an optical brightener and providing a given Y value is reformulated by reducing the amount of optical brightener by at least 20% and including a cellulase in an amount so that the Y value provided by the reformulated composition is equal to or higher than the Y value provided by the first detergent formulation.
59. The method according to paragraph 58, wherein the cellulase exhibits endo-beta-1,4-glucanase activity.
60. The method according to any of paragraphs 58 or 59, wherein the cellulase is obtainable by or derived from a strain of Bacillus, Humicola, Trichoderma, Myceliophthora, Penicillium, Irpex, Aspergillus, Scytalidium, Thielavia or Fusarium.
61. The method according to any of paragraphs 58-60 wherein the enzyme is obtainable by or derivable from a strain of Bacillus sp., preferable the strain DSM 12648, Humicola insolens, Fusarium oxysporum, Myceliophthora thermophile, Thielavia terrestris or Trichoderma reesei.
62. The method according to any of paragraphs 58-61, wherein the cellulase is selected from the group comprising:
   a. an endo-beta-1,4-glucanase enzyme having a sequence of at least 60% identity to the amino acid sequence of position 1 to position 773 of SEQ ID NO:1;
   b. the endo-beta-1,4-glucanase enzyme having the amino acid sequence of positions 1 to 773 in SEQ ID NO:1;
   c. an endo-beta-1,4-glucanase enzyme having a sequence of at least 60% identity to the amino acid sequence of position 1 to position 284 of SEQ ID NO: 2;
   d. the endo-beta-1,4-glucanase enzyme having the amino acid sequence of positions 1 to 284 in SEQ ID NO:2;
   e. an endo-beta-1,4-glucanase enzyme having a sequence of at least 60% identity to the amino acid sequence of position 1 to position 415 of SEQ ID NO:3;
   f. the endo-beta-1,4-glucanase enzyme having the amino acid sequence of positions 1 to 415 in SEQ ID NO:3;
   g. an endo-beta-1,4-glucanase enzyme having a sequence of at least 60% identity to the amino acid sequence of position 1 to position 278 of SEQ ID NO:4;
   h. the endo-beta-1,4-glucanase enzyme having the amino acid sequence of positions 1 to 278 in SEQ ID NO:4;
   i. a polypeptide endogenous to one of the following Bacillus species selected from the group consisting of: KSM S237, KSM 1139, KSM 64, KSM N131, KSM 635 (FERM BP 1485), KSM 534 (FERM BP 1508), KSM 53 (FERM BP 1509), KSM 577 (FERM BP 1510), KSM 521 (FERM BP 1507), KSM 580 (FERM BP 1511), KSM 588 (FERM BP 1513), KSM 597 (FERM BP 1514), KSM 522 (FERM BP 1512), KSM 3445 (FERM BP 1506), KSM 425 (FERM BP 1505), and mixtures thereof;
   j. an endoglucanase having a sequence of at least 60% identity to the amino acid sequence of SEQ. ID NO:5 or a variant obtained by substituting the amino acid residue of a cellulase having an amino acid sequence exhibiting at least 60 percent, preferably 95 percent, more preferably 98 percent or 99 percent identity with the amino acid sequence represented by SEQ. ID NO:5 at (a) position 10, (b) position 16, (c) position 22, (d) position 33, (e) position 39, (f) position 76, (g) position 109, (h) position 242, (i) position 263, (j) position 308, (k) position 462, (l) position 466, (m) position 468, (n) position 552, (o) position 564, and/or (p) position 608 in SEQ ID NO:5 and/or at a position corresponding thereto with another amino acid residue;
   k. an endoglucanase selected from the group consisting of the following endoglucanase variants: Egl-237, Egl-1139, Egl-64, Egl-N131b and mixtures thereof;
   l. a cellulase K having the following physical and chemical properties:
      i. Activity: Having a Cx enzymatic activity of acting on carboxymethyl cellulose along with a weak C1 enzymatic activity and a weak beta-glucoxidase activity;
      ii. Specificity on Substrates: Acting on carboxymethyl cellulose (CMC), crystalline cellulose, Avicell, cellobiose, and p-nitrophenyl cellobioside (PNPC);
      iii. Having a working pH in the range of 4 to 12 and an optimum pH in the range of 9 to 10;
      iv. Having stable pH values of 4.5 to 10.5 and 6.8 to 10 when allowed to stand at 40 degrees centigrade for 10 minutes and 30 minutes, respectively;
      v. Working in a wide temperature range of from 10 to 65 degrees centigrade with an optimum temperature being recognized at about 40 degrees C.;
      vi. Influences of chelating agents: The activity not impeded with ethylenediamine tetraacetic acid (EDTA), ethyleneglycol-bis-(beta-aminoethylether) N,N,N′,N″-tetraacetic acid (EGTA), N,N-bis(carboxymethyl)glycine (nitrilotriacetic acid) (NTA), sodium tripolyphosphate (STPP) and zeolite;
      vii. Influences of surface active agents: Undergoing little inhibition of activity by means of surface active agents such as sodium linear alkylbenzenesulfonates (LAS), sodium alkylsulfates (AS), sodium polyoxyethylene alkylsulfates (ES), sodium alphaolefinsulfonates (AOS), sodium alpha-sulfonated aliphatic acid esters (alpha-SFE), sodium alkylsulfonates (SAS), polyoxyethylene secondary alkyl ethers, fatty acid salts (sodium salts), and dimethyldialkylammonium chloride;
      viii. Having a strong resistance to proteinases; and
      ix. Molecular weight (determined by gel chromatography): Having a maximum peak at 180,000 plus or minus 10,000;
   m. a cellulase K obtained by isolation from a culture product of Bacillus sp KSM-635;
   n. an endoglucanase selected from the group consisting of:
      Cellulase K-534 from KSM 534, FERM BP 1508,
      Cellulase K-539 from KSM 539, FERM BP 1509,
      Cellulase K-577 from KSM 577, FERM BP 1510,
      Cellulase K-521 from KSM 521, FERM BP 1507,
      Cellulase K-580 from KSM 580, FERM BP 1511,
      Cellulase K-588 from KSM 588, FERM BP 1513,
      Cellulase K-597 from KSM 597, FERM BP 1514,
      Cellulase K-522 from KSM 522, FERM BP 1512,
      Cellulase E-II from KSM 522, FERM BP 1512,
      Cellulase E-III from KSM 522, FERM BP 1512,
      Cellulase K-344 from KSM 344, FERM BP 1506,
      Cellulase K-425 from KSM 425, FERM BP 1505,
      and mixtures thereof;
   o. an endoglucanase selected from the group consisting of endoglucanases derived from Bacillus species KSM-N, preferably the endoglucanase Egl-546H derived from Bacillus sp. KSM-N546;
   p. and mixtures thereof.
63. The method according to any of paragraphs 58-62, wherein the cellulase is comprised at a level of between 0.1 and 600 ECU/L wash liquid, preferably between 0.3 and 300, even more preferred between 0.5 and 100 or most preferred between 3 and 30 ECU/L wash liquid.
64. The method according to any of paragraphs 58-63, wherein the cellulase is comprised at a level of between 0.5 and 100 ECU/g detergent composition, preferably between 1 and 75, or even more preferred between 1.35 and 50 ECU/g detergent composition.
65. The method according to any of paragraphs 58-64, wherein the amount of optical brightener is reduced by at least 30%, preferably by at least 40% or more preferred by at least 50%, or by at least 60%, or even more preferred by at least 70%, or most preferred by at least 80% or even by at least 90%.
66. A method of washing a textile comprising a step of contacting said textile with the composition of any of paragraphs 45-57, then optionally washing and/or rinsing said textile.
67. Textile washed by the method of paragraph 66

### EXAMPLES

### Example 1

### Substitution of Optical Brightener in Liquid Detergents

Experiments were performed with two different kinds of liquid detergents.

The following conditions were used for both conditions:

Washing machine: US top loader

Washing volume: 68 L

Washing temperature (90° F.=32° C.)

Total wash time: Approximately 45 min

Main wash time: Approximately 12 min

Water hardness: 6° dH (Ca²⁺:Mg²⁺:HCO₃⁻=2:1:4.5)

Soil ballast: 2 WFK greying swatches (WFK socks)/wash available from WFK Testgewebe GmbH, Germany

Number of repetitive cycles for each condition: 10

Optical brightener used: Tinopal CBS-X from BASF (Ciba).

A detergent amylase and a detergent protease were additionally added to the detergents;

Amylase: Stainzyme 12L available from Novozymes NS: 0.1 g/wash

Protease: Savinase 16L available from Novozymes NS: 0.5 g/wash

Cellulase used: An enzyme product comprising a cellulase having SEQ ID NO. 3

### Example 1a Results

AATCC (American Association of Textile Chemists and Colorists) Standard Liquid Reference detergent without optical brighteners, 1× having the following composition:

| Component | Amount % |
|---|---|
| Linear sodium alkylbenzene sulfonate, sodium salt | 12.0 |
| Non-ionic surfactant | 8.0 |
| Citric acid (as sodium citrate) | 1.2 |
| Fatty acid (C24 sodium salt) | 4.0 |
| Caustic (NaOH) | 2.7 |
| Chelant (DTPA) | 0.3 |
| Stabilizers (propanediol) | 8.0 |
| Perservative (Borax) | 1.0 |
| Water/miscellaneous | 62.8 |
| Total | 100.0 |

Detergent dosage in experiment: 100 g/wash

TABLE 1
Y value (with UV in the illumination light)

| | | | 0.025 wt % |
|---|---|---|---|
| | | | Optical brightener + |
| | | | 15 ECU/g detergent |
| | 0.05 wt % | 0.025 wt % | (22 ECU/L wash |
| | Optical | Optical | liquid) of cellulase |
| Textile | brightener | brightener | having SEQ ID NO 3 |
| WFK 10 A | 88.7 | 88.4 | 90.8 |
| (woven cotton) | | | |
| T-460 | 89.9 | 89.5 | 92.0 |
| (knitted cotton) | | | |

This experiment clearly shows that reducing the percentage of optical brightener from 0.05 wt % to 0.025 wt % reduces the obtained Y value on knitted and woven cotton, however with the addition of 22 ECU/L wash liquid of the cellulase having SEQ ID No 3, the obtained Y value was increased, compared to the Y value obtained using the detergent composition having high level of optical brightener without a cellulase.

### Example 1b Results

ECO-friendly Laundry Detergent, Lavender, 2×. (Great Value Tranquil Lavender—US liquid available from Church & Dwight)

Detergent dosage in experiment: 50 g/wash

TABLE 2
Y value (with UV in the illumination light)

| | | | 0.05 wt % |
|---|---|---|---|
| | | | Optical brightener + |
| | | | 25 ECU/g detergent |
| | 0.1 wt % | 0.05 wt % | (18 ECU/L wash |
| | Optical | Optical | liquid) of cellulase |
| Textile | brightener | brightener | having SEQ ID NO 3 |
| T-460 | 90.0 | 87.1 | 90.1 |
| (knitted cotton) | | | |
| WFK 12 A W | 89.2 | 86.4 | 89.6 |
| (cotton terry towel) | | | |

This experiment clearly shows that reducing the percentage of optical brightener from 0.1 wt % to 0.05 wt % in this detergent reduces the Y value, however, with the addition of 18 ECU/L wash liquid of the cellulase having SEQ ID No 3, the obtained Y value was restored and even slightly increased compared to the Y value obtained using the detergent composition having high level of optical brightener without a cellulase.

### Example 2

### Substitution of Optical Brightener in Powder Detergents

The abovementioned effects in liquid detergents have been confirmed in various powder detergents.

### Example 2A

### EU Powder Detergent (Modified ECE-2 Available from WFK) Having the Following Composition

| Component | Amount/% |
|---|---|
| Surfactant system | |
| Linear sodium alkyl benzene sulfonate (mean C chain | 9.8 |
| length: 11.5) | |
| Ethoxylated fatty alcohol C-12-18 (7 EO) | 5.3 |
| Sodium soap (tallow soap) | 3.6 |
| Builder system | |
| Zeolite 4 A (80% active) | 32.9 |
| Sodium carbonate | 12 |
| Sodium silicate (SiO2:Na2═ = 3.3:1) | 3.4 |
| Sodium salt of a copolymer from acrylic and maleic acid | 5.3 |
| Phosphonate (Dequest 2066, 25% active acid) | 0.8 |
| Foam regulator | |
| Foam inhibitor (Silicone based) | 4.6 |
| Filler | |
| Sodium sulfate | 9.9 |
| Water | 12.4 |
| Total | 100 |

The following conditions were used:

Washing machine: EU front loader

Washing volume: 13 L

Washing temperature (30° C.)

Total wash time: Approximately 1 h 26 min

Main wash time: Approximately 43 min

Water hardness: 15° dH (Ca²⁺:Mg²⁺:HCO3=4:1:7.5)

Soil ballast: 1 WFK greying swatch (WFK sock)/wash

Number of repetitive cycles for each condition: 5

Optical brightener used: 4.4′-bis-(sulfostyryl)-biphenyl disodium salt provided from BASF as Tinopal CBS-X

A detergent amylase and a detergent protease were additionally added to the detergents;

Amylase: Stainzyme 12 T available from Novozymes NS: 0.2 g/wash

Protease: Savinase 12 T available from Novozymes NS: 0.7 g/wash

Cellulase used: an enzyme product comprising a cellulase having SEQ ID NO 1

Detergent dosage in experiment: 50 g/wash

### Results Ex. 2A

TABLE 3
Y value (with UV in the illumination light)

| | | | 0.13 wt % |
|---|---|---|---|
| | | | optical brightener + |
| | | | 4.5 ECU/g detergent |
| | 0.26 wt % | 0.13 wt % | (17.3 ECU/L wash |
| | optical | optical | liquid) of a cellulase |
| Textile | brightener | brightener | having SEQ ID NO 1 |
| WFK 10 A | 86.7 | 85.8 | 86.9 |
| (woven cotton) | | | |
| WFK 80 A | 88.8 | 88.0 | 89.0 |
| (knitted cotton) | | | |
| WFK 12 A W | 90.4 | 89.0 | 91.0 |
| (cotton terry towel) | | | |

This experiment confirms that the results obtained in liquid detergents are likewise obtained in a powder detergent. It is shown that reducing the percentage of optical brightener from 0.26 wt % to 0.13 wt %, i.e. by 50%, in this powder detergent reduces the obtained Y value, however, with the addition of 17.3 ECU/L wash liquid of the cellulase having SEQ ID NO 1, the obtained Y value was restored compared to the Y value obtained using the detergent composition having high level of optical brightener without a cellulase.

### Example 2B

### EU Powder Detergent—“Color” (Detergent without Bleaching Agent or Bleach Activator)

The following conditions were used:

Washing machine: EU front loader

Washing volume: 13 L

Washing temperature: 30 C

Total wash time 1 h 26 min

Main wash time: Approximately 43 min

Water hardness: 16 dH (Ca2+:Mg2+:HCO3−=4:1:7.5)

Soil ballast: 1 WFK graying swatch (WFK sock)/wash

Number of cycles for each condition: 5

Optical brightener used: 4.4′-bis-(sulfostyryl)-biphenyl disodium salt provided from BASF as Tinopal CBS-X.

A detergent amylase and a detergent protease were additionally added to the detergents;

Amylase: Stainzyme 12 T available from Novozymes NS: 0.2 g/wash

Protease: Savinase 12 T available from Novozymes NS: 0.7 g/wash

Cellulase used: An enzyme product comprising a cellulase having SEQ ID NO 1.

A detergent powder composition having the below formulation was prepared:

| Component | Amount/% |
|---|---|
| Surfactant system | |
| LAS, sodium salt | 12 |
| Non-ionic surfactant, C12-15 7 EO | 4 |
| Soap granulate | 2 |
| Builder system | |
| Zeolite 4A | 20 |
| Sodium carbonate | 10 |
| Sodium disilicate | 8 |
| Polycarboxylate - Sokalan CP 5 | 1 |
| granulate | |
| HEDP, sodium salt | 1 |
| Foam regulator | |
| Dow Corning 2 - 4248S | 2 |
| Filler | |
| Sodium sulfate | 40 |
| Total | 100 |

Results

TABLE 4
Y value (with UV in the illumination light)

| | | | 0.065 wt % |
|---|---|---|---|
| | | | optical brightener + |
| | | | 4.5 ECU/g detergent |
| | 0.26 wt % | 0.065 wt % | (17.3 ECU/L wash |
| | optical | optical | liquid) of a cellulase |
| Textile | brightener | brightener | having SEQ ID NO 1 |
| WFK 10 A | 80.32 | 79.26 | 83.15 |
| (woven cotton) | | | |
| WFK 80 A | 79.97 | 78.73 | 83.89 |
| (knitted cotton) | | | |
| WFK 12 A W | 79.17 | 78.83 | 85.14 |
| (cotton terry towel) | | | |
| PCN-01 | 81.04 | 79.57 | 82.42 |
| (polyester/cotton - | | | |
| 65%/35%) | | | |

### Example 2C

### EU Powder Detergent—“Bleach”

The conditions were as for example 2B.

A detergent composition having the below formulation was prepared.

| Component | Amount/% |
|---|---|
| Surfactant system | |
| LAS, sodium salt | 12 |
| Non-ionic surfactant, C11 7 EO | 4 |
| Soap granulate | 2 |
| Builder system | |
| Zeolite 4A | 20 |
| Sodium carbonate | 10 |
| Sodium disilicate | 8 |
| Polycarboxylate - Sokalan CP 5 | 1 |
| granulate | |
| HEDP, sodium salt | 1 |
| Bleach system | |
| Sodium percarbonate | 15 |
| TAED | 5 |
| Foam regulator | |
| Dow Corning 2 - 4248S | 2 |
| Filler | |
| Sodium sulfate | 20 |
| Total | 100 |

Results

TABLE 5
Y value (with UV in the illumination light).

| | | | 0.065 wt % |
|---|---|---|---|
| | | | optical brightener + |
| | | | 4.5 ECU/g detergent |
| | 0.26 wt % | 0.065 wt % | (17.3 ECU/L wash |
| | optical | optical | liquid) of a cellulase |
| Textile | brightener | brightener | having SEQ ID NO 1 |
| WFK 10 A | 83.8 | 82.1 | 85.3 |
| (woven cotton) | | | |
| WFK 80 A | 86.0 | 84.2 | 86.8 |
| (knitted cotton) | | | |
| WFK 12 A W | 82.9 | 81.0 | 83.9 |
| (cotton terry towel) | | | |

These experiments (examples 2B and 2C) further shows that the results obtained in liquid detergents are reproducible in various powder detergents. It is shown that reducing the percentage of optical brightener from 0.26 wt % to 0.065 wt %, i.e. a 75% reduction of optical brightener in powder detergent, reduces the obtained Y value, however, with the addition of 17.3 ECU/L wash liquid of the cellulase having SEQ ID NO 1, the obtained Y value was restored and for most of the tested textile swatches it was even improved compared to the Y value obtained using the detergent composition having high level of optical brightener without a cellulase.

1-15. (canceled)

16. A detergent composition comprising:
a. an optical brightener, at a level of at most 0.75% by weight of the composition,
b. a cellulase and
c. from 0.1 percent to 60 percent by weight of surfactant.

17. The detergent composition of claim 16, wherein the optical brightener is present at most 0.5% by weight of the composition.

18. The detergent composition of claim 16, wherein the optical brightener is present at most 0.4% by weight of the composition.

19. The detergent composition of claim 16, wherein the optical brightener is present at most 0.3% by weight of the composition.

20. The detergent composition of claim 16, wherein the optical brightener is present at most 0.26% by weight of the composition.

21. The detergent composition of claim 16, wherein the optical brightener is present at most 0.2% by weight of the composition.

22. The detergent composition of claim 16, wherein the optical brightener is present at most 0.1% by weight of the composition.

23. The detergent composition of claim 16, wherein the optical brightener is present at most 0.065% by weight of the composition.

24. The detergent composition of claim 16, wherein the optical brightener is present at most 0.05% by weight of the composition.

25. The detergent composition of claim 16, wherein the optical brightener is present at most 0.02% by weight of the composition.

26. The detergent composition of claim 16, wherein the optical brightener is present at most 0.005% by weight of the composition.

27. The detergent composition of claim 16, wherein the cellulase is obtainable by or derived from a strain of Bacillus, Humicola, Trichoderma, Myceliophthora, Penicillium, Irpex, Aspergillus, Scytalidium, Thielavia or Fusarium.

28. The detergent composition of claim 16, wherein the optical brightener is selected from the group consisting of benzenesulfonic acid, 2,2′-(1,2-ethenediyl)bis[5-[4-(4-morpholinyl)-6-(phenylamino)-1,3,5-triazin-2-yl]amino]-, disodium salt; 2,2′-([1,1′-biphenyl]-4,4′-diyldi-2,1-ethenediyl)bis-, disodium salt; diaminostilbene-sulphonic acid derivative including sodium salts of: 4,4′-bis-(2-diethanolamino-4-anilino-s-triazin-6-ylamino) stilbene-2,2′-disulphonate; 4,4′-bis-(2,4-dianilino-s-triazin-6-ylamino) stilbene-2.2′-disulphonate; 4,4′-bis-(2-anilino-4(N-methyl-N-2-hydroxy-ethylamino)-s-triazin-6-ylamino) stilbene-2,2′-disulphonate, 4,4′-bis-(4-phenyl-2,1,3-triazol-2-yl)stilbene-2,2′-disulphonate; 4,4′-bis-(2-anilino-4(1-methyl-2-hydroxy-ethylamino)-s-triazin-6-ylamino) stilbene-2,2′-disulphonate and/or 2-(stilbyl-4″-naptho-1.,2′:4,5)-1,2,3-trizole-2″-sulphonate; or 4,4′-bis-((2-morpholino-4 anilino-s-triazin-6-yl)amino) stilbene disulphonate or 2,2′-bis-(phenyl-styryl) disulphonate, 4.4′-bis-(sulfostyryl)-biphenyl disodium salt, 4′-bis[(4-anilino-6-morpholino-1,3,5-triazin-2-yl)amino]-stilbene-2,2′-disulfonate, and mixtures hereof.

29. A method for maintaining or improving the whiteness of a textile, comprising exposing the textile to a wash liquid which comprises a detergent composition of claim 16.

30. The method of claim 29, wherein the cellulase is obtainable by or derived from a strain of Bacillus, Humicola, Trichoderma, Myceliophthora, Penicillium, Irpex, Aspergillus, Scytalidium, Thielavia or Fusarium.

31. The method of claim 29, wherein the optical brightener is selected from the group consisting of benzenesulfonic acid, 2,2′-(1,2-ethenediyl)bis[5-[4-(4-morpholinyl)-6-(phenylamino)-1,3,5-triazin-2-yl]amino]-, disodium salt; 2,2′-([1,1′-biphenyl]-4,4′-diyldi-2,1-ethenediyl)bis-, disodium salt; diaminostilbene-sulphonic acid derivative including sodium salts of: 4,4′-bis-(2-diethanolamino-4-anilino-s-triazin-6-ylamino) stilbene-2,2′-disulphonate; 4,4′-bis-(2,4-dianilino-s-triazin-6-ylamino) stilbene-2.2′-disulphonate; 4,4′-bis-(2-anilino-4(N-methyl-N-2-hydroxy-ethylamino)-s-triazin-6-ylamino) stilbene-2,2′-disulphonate, 4,4′-bis-(4-phenyl-2,1,3-triazol-2-yl)stilbene-2,2′-disulphonate; 4,4′-bis-(2-anilino-4(1-methyl-2-hydroxy-ethylamino)-s-triazin-6-ylamino) stilbene-2,2′-disulphonate and/or 2-(stilbyl-4″-naptho-1.,2′:4,5)-1,2,3-trizole-2″-sulphonate; or 4,4′-bis-(2-morpholino-4 anilino-s-triazin-6-ylamino) stilbene disulphonate or 2,2′-bis-(phenyl-styryl) disulphonate, 4.4′-bis-(sulfostyryl)-biphenyl disodium salt, and mixtures hereof.

32. The method of claim 29, wherein the whiteness of the textile is maintained.

33. The method of claim 29, wherein the whiteness of the textile is improved.

34. A method for producing a detergent composition, comprising reformulating a first detergent formulation comprising an optical brightener and providing a given Y value by reducing the amount of optical brightener by at least 20% and including a cellulase in an amount so that the Y value provided by the reformulated composition is equal to or higher than the Y value provided by the first detergent formulation.

35. A method of washing a textile comprising contacting the textile with a detergent composition of claim 16, and then optionally washing and/or rinsing said textile.


SEQUENCE LISTING (5 sequences)

SEQ ID NO: 1 - protein, 802 aa, Bacillus sp.
  mat_peptide (30)..(802)
MKQQKRLYARLLTLLFALIFLLPHSAAAAAEGNTREDNFKHLLGNDNVKRPSEAGALQLQEVDGQMTLVDQHGEKIQLRGMSTHGLQWFPEILNDNAYKALANDWESNMIRLAMYVGENGYASNPELIKSRVIKGIDLAIENDMYVIVDWHVHAPGDPRDPVYAGAEDFFRDIAALYPNNPHIIYELANEPSSNNNGGAGIPNNEEGWNAVKEYADPIVEMLRDSGNADDNIIIVGSPNWSQRPDLAADNPINDHHTMYTVHFYTGSHAASTESYPPETPNSERGNVMSNTRYALENGVAVFATEWGTSQANGDGGPYFDEADVWIEFLNENNISWANWSLTNKNEVSGAFTPFELGKSNATNLDPGPDHVWAPEELSLSGEYVRARIKGVNYEPIDRTKYTKVLWDFNDGTKQGFGVNSDSPNKELIAVDNENNTLKVSGLDVSNDVSDGNFWANARLSADGWGKSVDILGAEKLTMDVIVDEPTTVAIAAIPQSSKSGWANPERAVRVNAEDFVQQTDGKYKAGLTITGEDAPNLKNIAFHEEDNNMNNIILFVGTDAADVIYLDNIKVIGTEVEIPVVHDPKGEAVLPSVFEDGTRQGWDWAGESGVKTALTIEEANGSNALSWEFGYPEVKPSDNWATAPRLDFWKSDLVRGENDYVAFDFYLDPVRATEGAMNINLVFQPPTNGYWVQAPKTYTINFDELEEANQVNGLYHYEVKINVRDITNIQDDTLLRNMMIIFADVESDFAGRVFVDNVRFEGAATTEPVEPEPVDPGEETPPVDEKEAKKEQKEAEKEEKEE

SEQ ID NO: 2 - protein, 305 aa, Humicola insolens
  mat_peptide (22)..(305)
MRSSPLLRSAVVAALPVLALAADGRSTRYWDCCKPSCGWAKKAPVNQPVFSCNANFQRITDFDAKSGCEPGGVAYSCADQTPWAVNDDFALGFAATSIAGSNEAGWCCACYELTFTSGPVAGKKMVVQSTSTGGDLGSNHFDLNIPGGGVGIFDGCTPQFGGLPGQRYGGISSRNECDRFPDALKPGCYWRFDWFKNADNPSFSFRQVQCPAELVARTGCRRNDDGNFPAVQIPSSSTSSPVNQPTSTSTTSTSTTSSPPVQPTTPSGCTAERWAQCGGNGWSGCTTCVAGSTCTKINDWYHQCL

SEQ ID NO: 3 - protein, 435 aa, Humicola insolens
  mat_peptide (21)..(435)
MARGTALLGLTALLLGLVNGQKPGETKEVHPQLTTFRCTKRGGCKPATNFIVLDSLSHPIHRAEGLGPGGCGDWGNPPPKDVCPDVESCAKNCIMEGIPDYSQYGVTTNGTSLRLQHILPDGRVPSPRVYLLDKTKRRYEMLHLTGFEFTFDVDATKLPCGMNSALYLSEMHPTGAKSKYNPGGAYYGTGYCDAQCFVTPFINGLGNIEGKGSCCNEMDIWEANSRASHVAPHTCNKKGLYLCEGEECAFEGVCDKNGCGWNNYRVNVTDYYGRGEEFKVNTLKPFTVVTQFLANRRGKLEKIHRFYVQDGKVIESFYTNKEGVPYTNMIDDEFCEATGSRKYMELGATQGMGEALTRGMVLAMSIWWDQGGNMEWLDHGEAGPCAKGEGAPSNIVQVEPFPEVTYTNLRWGEIGSTYQEVQKPKPKPGHGPRSD

SEQ ID NO: 4 - protein, 299 aa, Thielavia terrestris
  mat_peptide (22)..(299)
MRSTPVLRTTLAAALPLVASAASGSGQSTRYWDCCKPSCAWPGKAAVSQPVYACDANFQRLSDFNVQSGCNGGSAYSCADQTPWAVNDNLAYGFAATSIAGGSESSWCCACYALTFTSGPVAGKTMVVQSTSTGGDLGSNQFDIAMPGGGVGIFNGCSSQFGGLPGAQYGGISSRDQCDSFPAPLKPGCQWRFDWFQNADNPTFTFQQVQCPAEIVARSGCKRNDDSSFPVFTPPSGGNGGTGTPTSTAPGSGQTSPGGGSGCTSQKWAQCGGIGFSGCTTCVSGTTCQKLNDYYSQCL

SEQ ID NO: 5 - protein, 824 aa, bacillus sp.
  mat_peptide (30)..(824)
MMLRKKTKQLISSILILVLLLSLFPAALAAEGNTREDNFKHLLGNDNVKRPSEAGALQLQEVDGQMTLVDQHGEKIQLRGMSTHGLQWFPEILNDNAYKALSNDWDSNMIRLAMYVGENGYATNPELIKQRVIDGIELAIENDMYVIVDWHVHAPGDPRDPVYAGAKDFFREIAALYPNNPHIIYELANEPSSNNNGGAGIPNNEEGWKAVKEYADPIVEMLRKSGNADDNIIIVGSPNWSQRPDLAADNPIDDHHTMYTVHFYTGSHAASTESYPSETPNSERGNVMSNTRYALENGVAVFATEWGTSQASGDGGPYFDEADVWIEFLNENNISWANWSLTNKNEVSGAFTPFELGKSNATNLDPGPDHVWAPEELSLSGEYVRARIKGVNYEPIDRTKYTKVLWDFNDGTKQGFGVNSDSPNKELIAVDNENNTLKVSGLDVSNDVSDGNFWANARLSANGWGKSVDILGAEKLTMDVIVDEPTTVAIAAIPQSSKSGWANPERAVRVNAEDFVQQTDGKYKAGLTITGEDAPNLKNIAFHEEDNNMNNIILFVGTDAADVIYLDNIKVIGTEVEIPVVHDPKGEAVLPSVFEDGTRQGWDWAGESGVKTALTIEEANGSNALSWEFGYPEVKPSDNWATAPRLDFWKSDLVRGENDYVAFDFYLDPVRATEGAMNINLVFQPPTNGYWVQAPKTYTINFDELEEANQVNGLYHYEVKINVRDITNIQDDTLLRNMMIIFADVESDFAGRVFVDNVRFEGAATTEPVEPEPVDPGEETPPVDEKEAKKEQKEAEKEEKEAVKEEKKEAKEEKKAVKNEAKKK